(19) United States
(12) Patent Application Publication
(10) Pub. No.: US 2018/0059566 A1
(43) Pub. Date: Mar. 1, 2018

(54) UV-CURABLE LIQUID DEVELOPER, FIXING METHOD, IMAGE FORMING METHOD, AND UV-CURABLE COMPOSITION

(71) Applicant: CANON KABUSHIKI KAISHA, Tokyo (JP)

(72) Inventors: Hiroshi Tanabe, Yokohama-shi (JP); Junji Ito, Hiratsuka-shi (JP); Yasuhiro Aichi, Tokyo (JP); Jun Shirakawa, Kawaguchi-shi (JP); Koichi Nakata, Tokyo (JP)

(21) Appl. No.: 15/559,876

(22) PCT Filed: May 24, 2016
(86) PCT No.: PCT/JP2016/065845

§ 371 Date: Sep. 20, 2017

(30) Foreign Application Priority Data
May 27, 2015 (JP) 2015-107592
May 18, 2016 (JP) 2016-099608

(51) Int. Cl. G03G 9/135; G03G 9/125; G03G 15/08; G03G 15/10; G03G 15/20

(52) U.S. Cl. CPC G03G 9/1355; G03G 9/125; G03G 15/20; G03G 15/10; G03G 15/08

(57) ABSTRACT

Provided is a UV-curable liquid developer remaining in an apparatus hardly cures with visible light even when the apparatus is opened for the purpose of, for example, its maintenance, and the UV-curable liquid developer shows sufficient fixability by irradiation of the UV light. The UV-curable liquid developer includes: toner particles; a polymerization initiator; a sensitizer; and a polymerizable monomer, in which the sensitizer contains a compound represented by X—Y, where X represents a triphenylenyl group or the like and Y represents a triphenylenyl group or the like.

### TECHNICAL FIELD

The present invention relates to a UV-curable liquid developer to be used in an electrophotographic image forming apparatus or an image forming method utilizing an electrophotographic system, such as an electrophotographic method, an electrostatic recording method, or electrostatic recording printing, and to a fixing method and an image forming method each involving using the UV-curable liquid developer.

The present invention also relates to a UV-curable composition.

### BACKGROUND ART

An electrophotographic system is a method of obtaining an image (printed product) involving: uniformly charging a surface of an image bearing member, such as a photosensitive member (charging step); exposing the surface of the image bearing member to light to form an electrostatic latent image thereon (exposing step); developing the formed electrostatic latent image with a developer containing toner particles (coloring resin particles) to form a toner image (developer image) (developing step); transferring the toner image onto a recording medium, such as paper or a plastic film (transferring step); and fixing the transferred toner image to the recording medium (fixing step).

The developers are roughly classified into: a dry developer in which toner particles each including materials including a colorant, such as a pigment, and a binder resin are used in dry states; and a liquid developer in which the toner particles are used after having been dispersed in a liquid, such as an electrically insulating liquid.

In recent years, there have been growing needs for color printing and high-speed printing in electrophotographic image forming apparatus, such as a copying machine, a facsimile, and a printer each utilizing the electrophotographic system. In the color printing, a high-resolution and high-quality image is required, and hence a developer that can form a high-resolution and high-quality color image, and is applicable to the high-speed printing has been required.

The liquid developer has been known as a developer that is advantageous in terms of the reproducibility of a color image. In the liquid developer, fine toner particles can be used because the aggregation of the toner particles in the liquid developer during its storage hardly occurs. Accordingly, the liquid developer easily provides excellent characteristics in terms of the reproducibility of a thin-line image and gradation reproducibility. The following digital printing apparatus has started to be vigorously developed through a good use of those excellent advantages. The apparatus can print a high-quality image at a high speed through the utilization of an electrophotographic technology involving using the liquid developer. Under such circumstances, the development of a liquid developer having additionally satisfactory characteristics has been required.

A developer obtained by dispersing toner particles in an electrically insulating liquid, such as a hydrocarbon organic solvent or a silicone oil, has heretofore been known as the liquid developer.

However, when the electrically insulating liquid remains on a recording medium, such as paper or a plastic film, a remarkable reduction in image quality may occur, and hence the electrically insulating liquid needs to be removed.

A general method for the removal of the electrically insulating liquid involves applying thermal energy to volatilize and remove the electrically insulating liquid.

However, the method is not necessarily preferred from the viewpoints of the environment and energy saving because an organic solvent vapor may be emitted to the outside of the apparatus or a great deal of energy is required at the time of the removal.

A method involving curing the electrically insulating liquid through photopolymerization has been proposed as a countermeasure against the foregoing. A developer obtained as described below is used as a photocurable liquid developer. A monomer having a reactive functional group is used as the electrically insulating liquid, and a photopolymerization initiator is dissolved therein. The photocurable liquid developer is cured by subjecting the reactive functional group to a reaction through irradiation with light, such as UV light, and is applicable to the high-speed printing. Such photocurable liquid developer has been proposed in Patent Literature 1.

In addition, in Patent Literature 2, there is a proposal that a curable liquid vehicle having a specific resistance value range be used as a curable electrically insulating liquid. Cationic polymerizable monomers, such as an epoxy compound, vinyl ether, and a cyclic vinyl ether, are given as examples of the curable liquid vehicle. Of those, a vinyl ether monomer is suitable as a curable electrically insulating liquid vehicle because the monomer easily provides a high volume resistivity and has a fast reaction rate.

Further, the photocurable liquid developer is generally cured with UV light. Various UV lamps, such as a mercury lamp, a metal halide lamp, an excimer laser, a UV laser, a cold-cathode tube, a hot-cathode tube, and a black light, can each be used as a light source for the UV light. Of those, a UV light emitting diode (LED) that emits UV light having a wavelength of 365 nm or UV light having a wavelength of 385 nm has been generally used in recent years because the LED has a small size and is available at a relatively low cost.

However, a polymerization initiator excellent in curability out of the polymerization initiators to be used in such cationic polymerization-type curable developers as described above generally has absorption in a short wavelength region ranging from about 250 nm to about 350 nm. Accordingly, the polymerization initiator is free of any sensitivity, or has insufficient sensitivity, to light in an ultraviolet region having a wavelength of about 360 nm or more and about 390 nm or less.

Accordingly, the following system has been known. In addition to the polymerization initiator, a sensitizer, such as a thioxanthone-based material or an anthracene-based material, is added to impart absorption sensitivity to such wavelength to the developer so that the developer may be cured with UV light. In Non Patent Literature 1, pyrene, perylene, acridine orange, thioxanthone, 2-chlorothioxanthone, benzofuran, N-vinylcarbazole, anthraquinone, coumarin, ketocoumarin, phenanthrene, camphorquinone, a phenothiazine derivative, and the like are listed as other sensitizer materials.

### CITATION LIST

### Patent Literature

PTL 1: Japanese Patent Application Laid-Open No. 2003-57883

PTL 2: Japanese Patent No. 3442406

### Non Patent Literature

NPL 1: J. V. Crivello, Advances in Polymer Science, Vol. 62, 1 (1984)

### SUMMARY OF INVENTION

### Technical Problem

The addition of the sensitizer, such as the thioxanthone-based material or the anthracene-based material, drastically improves the curability of a liquid developer when the developer is irradiated with UV light having a wavelength of 360 nm or more and 390 nm or less.

Meanwhile, such sensitizer has absorption for light in a visible light region, e.g., light having a wavelength of 400 nm or more and 430 nm or less as well, and hence the liquid developer may cure even when exposed to light from an electric lamp or a fluorescent lamp. Particularly in the case of an electrophotographic image forming apparatus using the liquid developer, when the electrophotographic image forming apparatus is opened for the purpose of, for example, the maintenance of the electrophotographic image forming apparatus, the following problem occurs. The developer remaining at a site, such as the surface of a photosensitive drum, is cured with light from an electric lamp or a fluorescent lamp.

In Non Patent Literature 1, sensitizer materials each free of any absorption for light having a wavelength of 400 nm or more and 430 nm or less are also listed.

However, the absorption edges of those materials shift to shorter wavelengths ranging from about 250 nm to about 350 nm. Accordingly, most of the compounds are each free of any absorption for UV light having a wavelength of 360 nm or more and 390 nm or less, or each have extremely weak absorption therefor, and hence a sufficient sensitizing action is not obtained at UV light having a wavelength of 360 nm or more and 390 nm or less.

An object of the present invention is to provide the following UV-curable liquid developer. While showing a sufficient sensitizing action on UV light, the UV-curable liquid developer remaining in an electrophotographic image forming apparatus hardly cures even when the electrophotographic image forming apparatus is opened for the purpose of, for example, its maintenance.

### Solution to Problem

According to one embodiment of the present invention, there is provided a UV-curable liquid developer, including:

toner particles;

a photopolymerization initiator;

a sensitizer; and

a polymerizable monomer,

in which the sensitizer contains a compound represented by the following formula (1):

X—Y (1)

in the formula (1):

X represents one functional group selected from the group consisting of a triphenylenyl group, a phenanthrenyl group, a pyrenyl group, a fluoranthenyl group, a fluorenyl group, a chrysenyl group, a carbazolyl group, a dibenzofuranyl group, a dibenzothiophenyl group, and a naphthyl group;

Y represents one functional group selected from the group consisting of a triphenylenyl group, a phenanthrenyl group, a pyrenyl group, a fluoranthenyl group, a fluorenyl group, a chrysenyl group, a carbazolyl group, a dibenzofuranyl group, a dibenzothiophenyl group, a naphthyl group, a phenyl group, a biphenyl group, and a terphenyl group; and

X and Y may each independently have a substituent selected from the group consisting of an alkyl group, a fluoroalkyl group, a cycloalkyl group, an alkenyl group, a cycloalkenyl group, an alkoxy group, an alkylthio group, a hydroxy group, a halogen atom, a cyano group, a carbonyl group, a carboxy group, an oxycarbonyl group, a carbamoyl group, an amino group, a silyl group, a nitro group, and a sulfonic group.

According to another embodiment of the present invention, there is provided a method of fixing a UV-curable liquid developer, including irradiating the above-mentioned UV-curable liquid developer with UV light having a wavelength of 360 nm or more and 390 nm or less to cure the UV-curable liquid developer.

According to still another embodiment of the present invention, there is provided an image forming method, including:

a charging step of charging a surface of a photosensitive member;

an exposing step of forming an electrostatic latent image on the surface of the photosensitive member through exposure;

a developing step of developing the formed electrostatic latent image with a developer to form a toner image;

a transferring step of transferring the toner image onto a recording medium; and

a fixing step of fixing the transferred toner image to the recording medium,

in which:

the developer includes the UV-curable liquid developer; and

the fixing step includes irradiating the UV-curable liquid developer with UV light having a wavelength of 360 nm or more and 390 nm or less to cure the UV-curable liquid developer.

According to still another embodiment of the present invention, there is provided a UV-curable composition, including:

a photopolymerization initiator;

a sensitizer; and

a polymerizable monomer,

in which the sensitizer contains a compound represented by the formula (1).

### Advantageous Effects of Invention

According to the present invention, the following UV-curable liquid developer can be provided. While showing a sufficient sensitizing action on UV light having a wavelength of 360 nm or more and 390 nm or less, the liquid developer remaining in an apparatus hardly cures even when the apparatus is opened for the purpose of, for example, its maintenance.

Further features of the present invention will become apparent from the following description of exemplary embodiments with reference to the attached drawings.

### BRIEF DESCRIPTION OF DRAWINGS

FIG. 1A is a ¹H-NMR spectrum of Exemplified Compound C-45 synthesized in Synthesis Example 1.

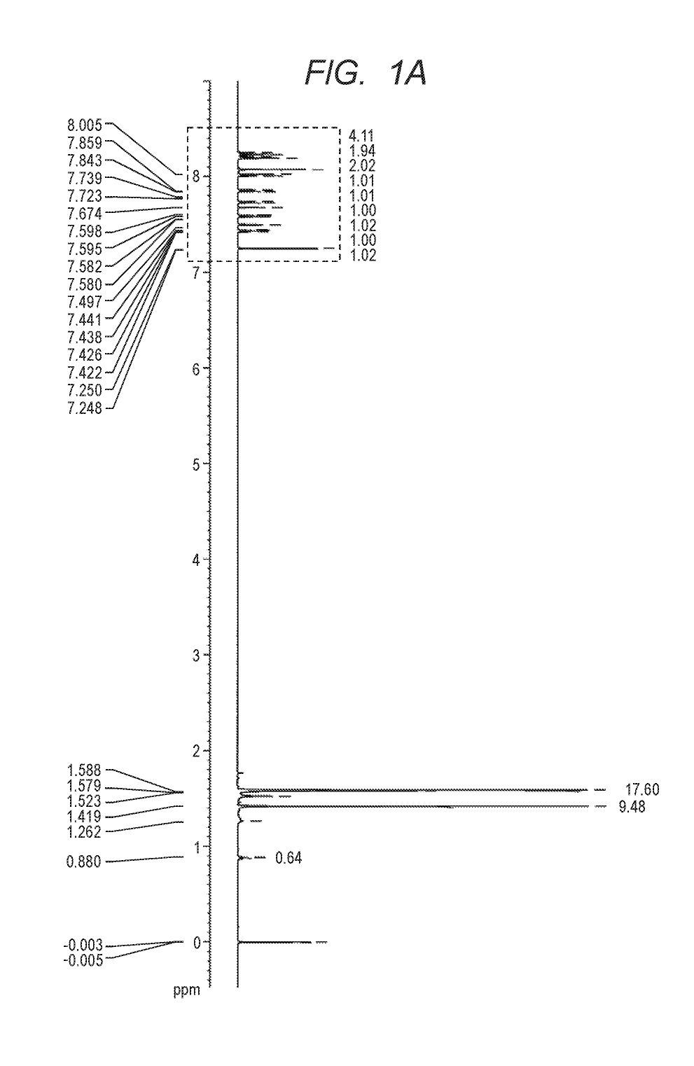

FIG. 1B is an enlarged view of the low-magnetic field region (broken line portion in FIG. 1A) of the ¹H-NMR spectrum of Exemplified Compound C-45 shown in FIG. 1A.

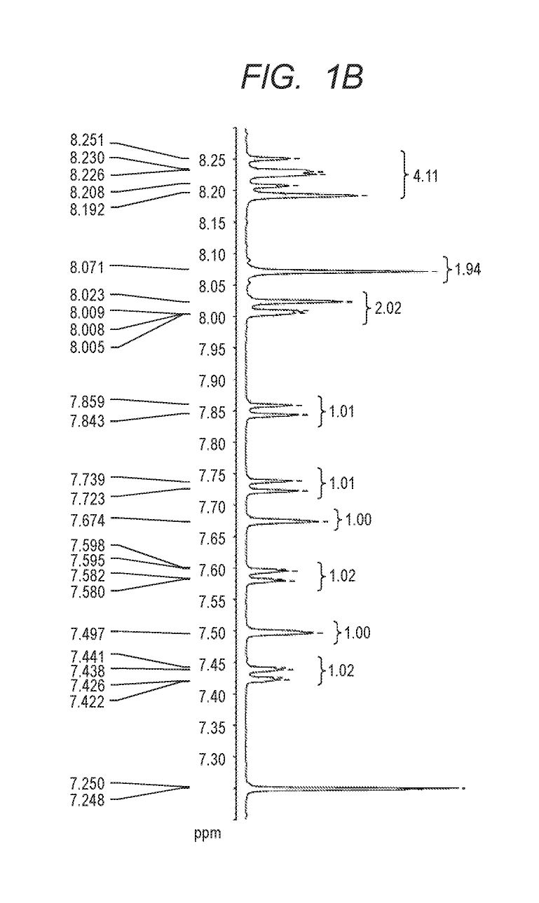

FIG. 2A is a ¹H-NMR spectrum of Exemplified Compound C-42 synthesized in Synthesis Example 2.

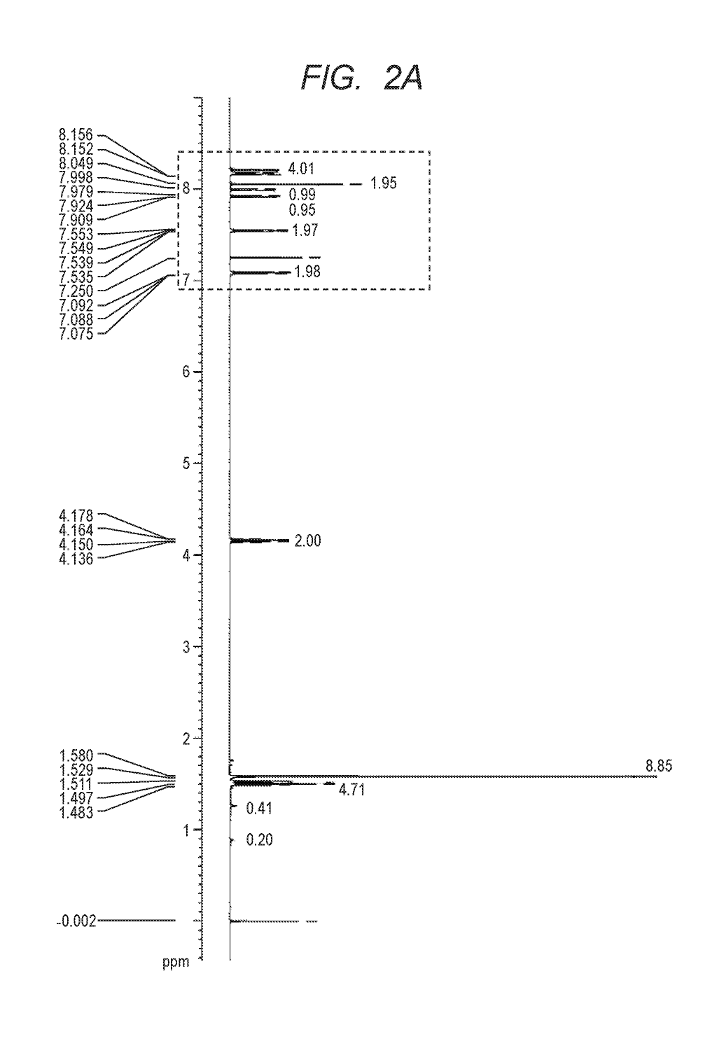

FIG. 2B is an enlarged view of the low-magnetic field region (broken line portion in FIG. 2A) of the ¹H-NMR spectrum of Exemplified Compound C-42 shown in FIG. 2A.

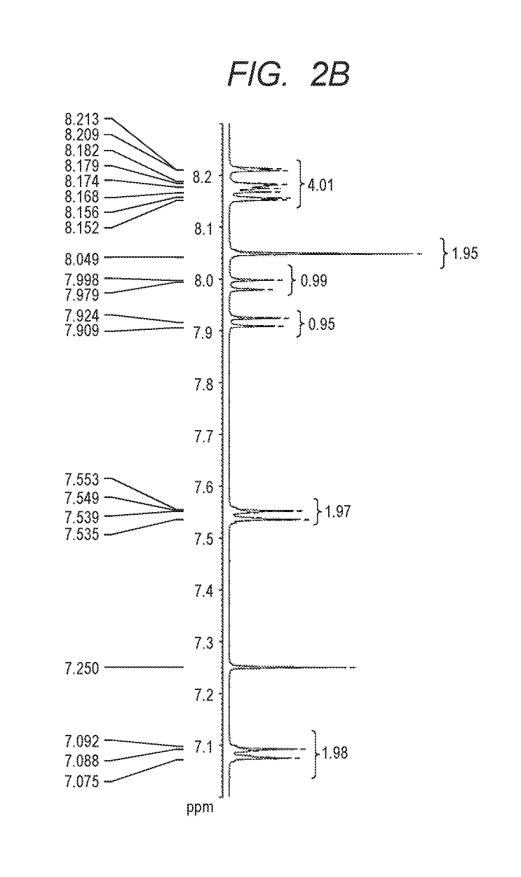

### DESCRIPTION OF EMBODIMENTS

Preferred embodiments of the present invention will now be described in detail in accordance with the accompanying drawings.

A UV-curable liquid developer of the present invention contains toner particles, a photopolymerization initiator, a sensitizer, and a polymerizable monomer. The toner particles are preferably insoluble in the polymerizable monomer.

In addition, a UV-curable composition of the present invention contains a photopolymerization initiator, a sensitizer, and a polymerizable monomer.

The respective constituent components to be incorporated into the UV-curable liquid developer or UV-curable composition of the present invention are described below.

[Photopolymerization Initiator]

The photopolymerization initiator that can be preferably used in the UV-curable liquid developer or UV-curable composition of the present invention is a compound represented by the following formula (2).

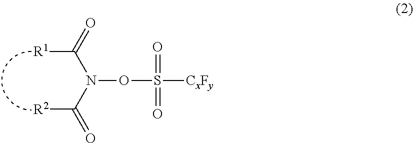

In the formula (2), x represents an integer of 1 or more and 8 or less, y represents an integer of 3 or more and 17 or less, and R¹ and R² represent groups that are bonded to each other to form a cyclic imide structure.

The use of the photopolymerization initiator containing the compound represented by the formula (2) provides a liquid developer having a high resistance unlike the case where an ionic photo-acid generator is used while enabling satisfactory fixation.

The compound represented by the formula (2) serving as the photopolymerization initiator undergoes photodecomposition through irradiation with UV light to generate a sulfonic acid serving as a strong acid. In addition, when the photopolymerization initiator is used in combination with a sensitizer, the decomposition of the photopolymerization initiator and the generation of the sulfonic acid can be triggered by the absorption of UV light by the sensitizer.

Examples of the cyclic imide structure which R¹ and R² are bonded to each other to form can include a five-membered ring imide and a six-membered ring imide. In addition, a functional group containing R¹ and R² is a functional group for generating the sulfonic acid through irradiation with UV light. Therefore, the cyclic imide structure which R¹ and R² are bonded to each other to form may be any structure (functional group) as long as the compound represented by the formula (2) can absorb UV light. For example, a structure containing an aromatic group, such as a phenyl group or a naphthyl group, is preferred.

The compound represented by the formula (2) is preferably such that a functional group (structure) containing R¹ and R² in the formula (2) is a naphthyl group like a compound represented by the following formula (3).

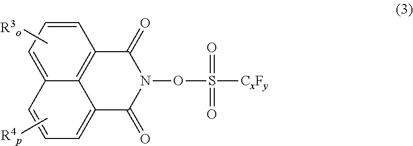

In the formula (3), R³ and R⁴ each independently represent a substituent selected from the group consisting of an alkyl group, an alkyloxy group, an alkylthio group, an aryl group, and an aryloxy group, and o and p each independently represent an integer of 0 or more and 3 or less.

In addition, even when the functional group containing R¹ and R² of the compound represented by the formula (2) is a functional group that does not absorb UV light, the compound represented by the formula (2) can be decomposed by using a sensitizer to be described later. Accordingly, the functional group containing R¹ and R² may be, for example, an alkylene group, such as a methylene group or an ethylene group, or a cycloalkylene group, such as a cyclopentylene group or a cyclohexylene group, which does not absorb the UV light.

The functional group containing R¹ and R² in the formula (2) may have as a substituent an alkyl group, an alkyloxy group, an alkylthio group, an aryl group, an aryloxy group, an arylthio group, or the like. Further, the functional group containing R¹ and R² may be condensed with any one of the other ring structures, such as an alicycle, a heterocycle, and an aromatic ring each of which may have a substituent.

The alkyl moiety of each of the alkyl group, the alkyloxy group, and the alkylthio group each serving as the substituent needs only to be such that the photopolymerization initiator can generate a sulfonic acid at the time of the use of the UV-curable liquid developer of the present invention. Any one of the linear, branched, and cyclic alkyl moieties is permitted as long as the foregoing condition is satisfied. Examples of the alkyl moiety include a methyl group, an ethyl group, a n-propyl group, an i-propyl group, a n-butyl group, a s-butyl group, a t-butyl group, an i-butyl group, a cyclopentyl group, a cyclohexyl group, and a decahydronaphthalenyl group.

The aryl moiety of each of the aryl group, the aryloxy group, and the arylthio group each serving as the substituent may be any aryl moiety as long as the photopolymerization initiator can generate a sulfonic acid at the time of the use of the UV-curable liquid developer of the present invention. Examples of the aryl moiety include a phenyl group and a naphthyl group.

Examples of the group represented by any one of R³ and R⁴ in the formula (3) include the same groups as the substituent of the functional group containing R¹ and R². It is preferred that o and p each representing the number of substituents each independently represent an integer of 0 or more and 3 or less.

The ring structure condensed with the functional group may be any ring structure as long as the photopolymerization initiator can generate a sulfonic acid at the time of the use of the UV-curable liquid developer of the present invention. An example thereof is a ring structure that forms, for example, cyclohexane, norbornene, decahydronaphthalene, 1,4-epoxy-1,2,3,4-tetrahydrobenzene, benzodithiane, xanthone, or thioxanthone through annelation.

CₓF_{y} represents a fluorocarbon group having a large electron-withdrawing property, and the group has 1 or more and 8 or less carbon atoms (x=1 to 8), and has 3 or more and 17 or less fluorine atoms (y=3 to 17).

When the number of carbon atoms is 1 or more, the synthesis of the strong acid becomes easy, and when the number is 8 or less, the initiator is excellent in storage stability. When the number of fluorine atoms is 3 or more, the initiator can act as a strong acid, and when the number is 17 or less, the synthesis of the compound represented by the formula (2) becomes easy.

Examples of CₓF_{y} in the formula (2) include a linear alkyl group (RF1) in which a hydrogen atom is substituted by a fluorine atom, a branched alkyl group (RF2) in which a hydrogen atom is substituted by a fluorine atom, a cycloalkyl group (RF3) in which a hydrogen atom is substituted by a fluorine atom, and an aryl group (RF4) in which a hydrogen atom is substituted by a fluorine atom.

Examples of the linear alkyl group (RF1) in which a hydrogen atom is substituted by a fluorine atom include a trifluoromethyl group (x=1 and y=3), a pentafluoroethyl group (x=2 and y=5), a heptafluoro-n-propyl group (x=3 and y=7), a nonafluoro-n-butyl group (x=4 and y=9), a perfluoro-n-hexyl group (x=6 and y=13), and a perfluoro-n-octyl group (x=8 and y=17).

Examples of the branched alkyl group (RF2) in which a hydrogen atom is substituted by a fluorine atom include a perfluoroisopropyl group (x=3 and y=7), a perfluoro-tert-butyl group (x=4 and y=9), and a perfluoro-2-ethylhexyl group (x=8 and y=17).

Examples of the cycloalkyl group (RF3) in which a hydrogen atom is substituted by a fluorine atom include a perfluorocyclobutyl group (x=4 and y=7), a perfluorocyclopentyl group (x=5 and y=9), a perfluorocyclohexyl group (x=6 and y=11), and a perfluoro(1-cyclohexyl)methyl group (x=7 and y=13).

Examples of the aryl group (RF4) in which a hydrogen atom is substituted by a fluorine atom include a pentafluorophenyl group (x=6 and y=5) and a 3-trifluoromethyltetrafluorophenyl group (x=7 and y=7).

CₓF_{y} in the formula (2) represents preferably a linear alkyl group (RF1), a branched alkyl group (RF2), or an aryl group (RF4), more preferably a linear alkyl group (RF1) or an aryl group (RF4) from the viewpoints of easy availability of the compound represented by the formula (2) and the decomposability of a sulfonic acid ester moiety. The following group is particularly preferred: a trifluoromethyl group (x=1 and y=3), a pentafluoroethyl group (x=2 and y=5), a heptafluoro-n-propyl group (x=3 and y=7), a nonafluoro-n-butyl group (x=4 and y=9), or a pentafluorophenyl group (x=6 and y=5).

Specific examples [Exemplified Compounds A-1 to A-27] of the photopolymerization initiator are given below.

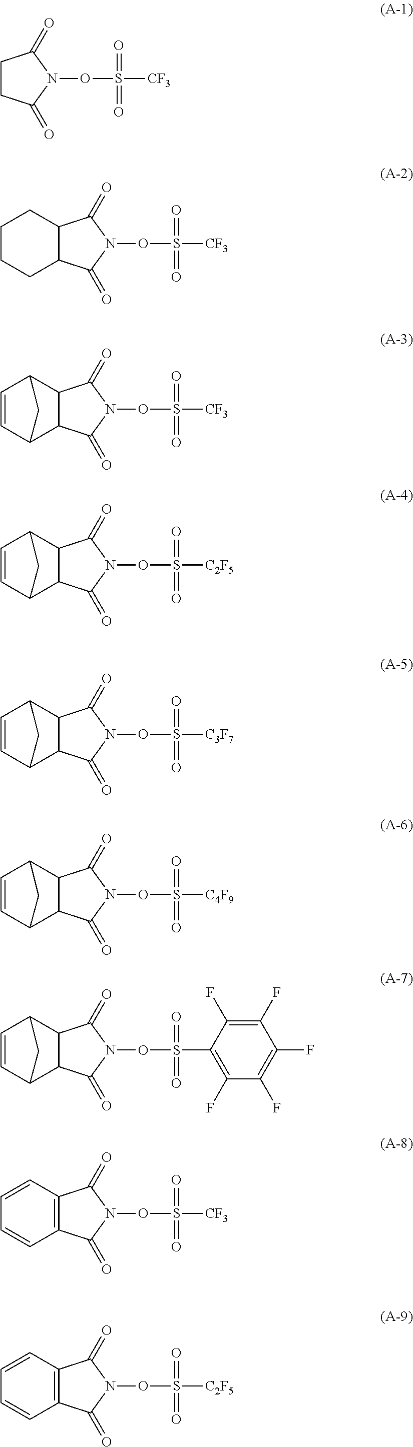

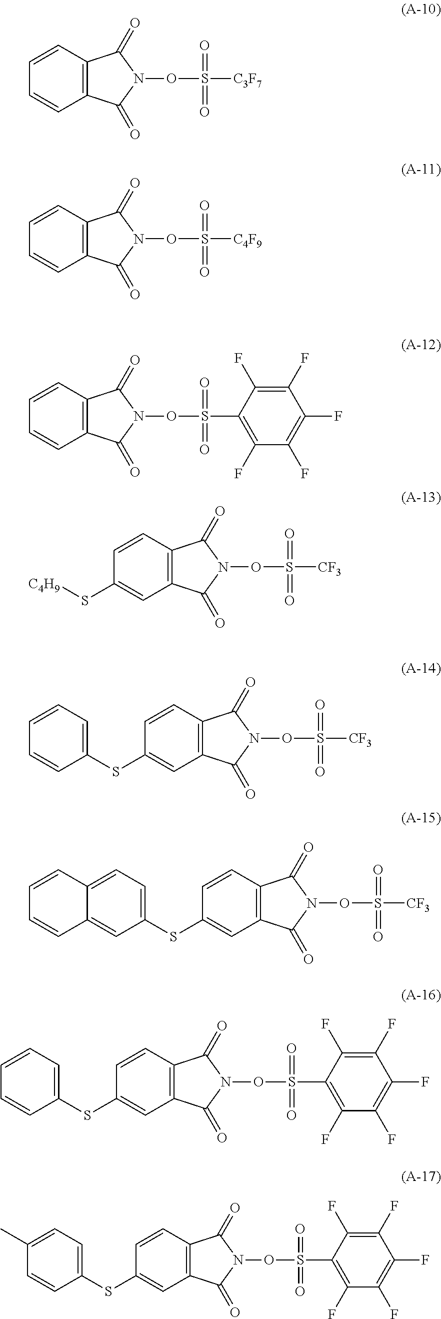

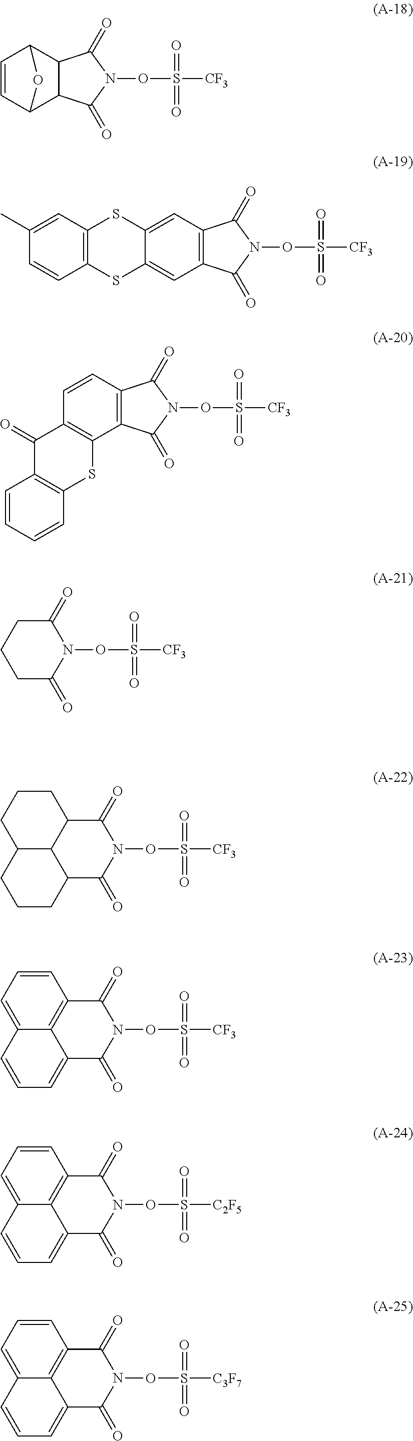

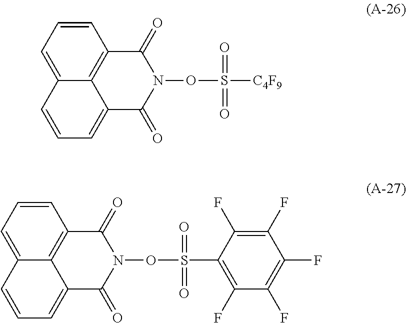

One kind of the photopolymerization initiators can be used, or two or more kinds thereof can be used in combination. With regard to the content of the photopolymerization initiator in the UV-curable liquid developer of the present invention, as the content becomes larger, its fixability is improved. As the content becomes smaller, the following tendency is observed: the volume resistivity of the developer increases and hence its developability is improved.

When the foregoing is considered, the content of the photopolymerization initiator is preferably 0.01 part by mass or more and 5 parts by mass or less, more preferably 0.05 part by mass or more and 1 part by mass or less, still more preferably 0.1 part by mass or more and 0.5 part by mass or less with respect to 100 parts by mass of the UV-curable liquid developer or UV-curable composition of the present invention.

In addition, the photopolymerization initiator is preferably a compound free of any absorption in the visible region when the fact that an electrophotographic image forming apparatus may be opened for the purpose of, for example, its maintenance is considered.

[Vinyl Ether Compound]

In the UV-curable liquid developer or UV-curable composition of the present invention, the polymerizable monomer is preferably a cationic polymerizable liquid monomer, and out of such monomers, a vinyl ether compound is preferred. When the vinyl ether compound is used, a UV-curable liquid developer having a high electric resistance, a low viscosity, and high sensitivity is easily obtained. The inventors of the present invention have assumed that the expression of the suitable characteristics results from the fact that the bias of an electron density in a molecule of the vinyl ether compound is small.

In general, anionic polymerizable acrylic monomers, cationic polymerizable cyclic ether monomers, such as epoxy and oxetane, and the like have been widely known as polymerizable liquid monomers.

However, an electron density in a molecule of an acrylic monomer is biased and hence an electrostatic interaction acts between the molecules thereof. Accordingly, a liquid developer having a low viscosity is hardly obtained and the resistance of a developer to be obtained tends to be low. A cyclic ether monomer also hardly obtains a high electric resistance and its reaction rate is slower than that of the vinyl ether compound, and hence it is difficult to apply the monomer to high-speed printing.

In the present invention, the following aspect is also one preferred aspect: the vinyl ether compound is a compound free of any heteroatom except in a vinyl ether structure. Here, the term “heteroatom” refers to an atom except a carbon atom and a hydrogen atom. When the compound is free of any heteroatom except in the vinyl ether structure, the bias of an electron density in a molecule thereof is suppressed and hence a high volume resistivity is easily obtained.

In the present invention, the vinyl ether compound is preferably represented by the following formula (C).

(H₂C═CH—OₙR (C)

In the formula (C), n represents the number of vinyl ether structures in one molecule. n preferably represents an integer of 1 or more and 4 or less, and more preferably represents an integer of 1 or more and 3 or less.

R represents an n-valent hydrocarbon group.

R preferably represents a group selected from the group consisting of: a linear or branched and saturated or unsaturated aliphatic hydrocarbon group having 1 or more and 20 or less carbon atoms; a saturated or unsaturated alicyclic hydrocarbon group having 5 or more and 12 or less carbon atoms; and an aromatic hydrocarbon group having 6 or more and 14 or less carbon atoms. The alicyclic hydrocarbon group and the aromatic hydrocarbon group may each have a saturated or unsaturated aliphatic hydrocarbon group having 1 or more and 4 or less carbon atoms. The R more preferably represents a linear or branched and saturated aliphatic hydrocarbon group having 4 or more and 18 or less carbon atoms.

Specific examples [Exemplified Compounds B-1 to B-30] of the vinyl ether compound are given below.

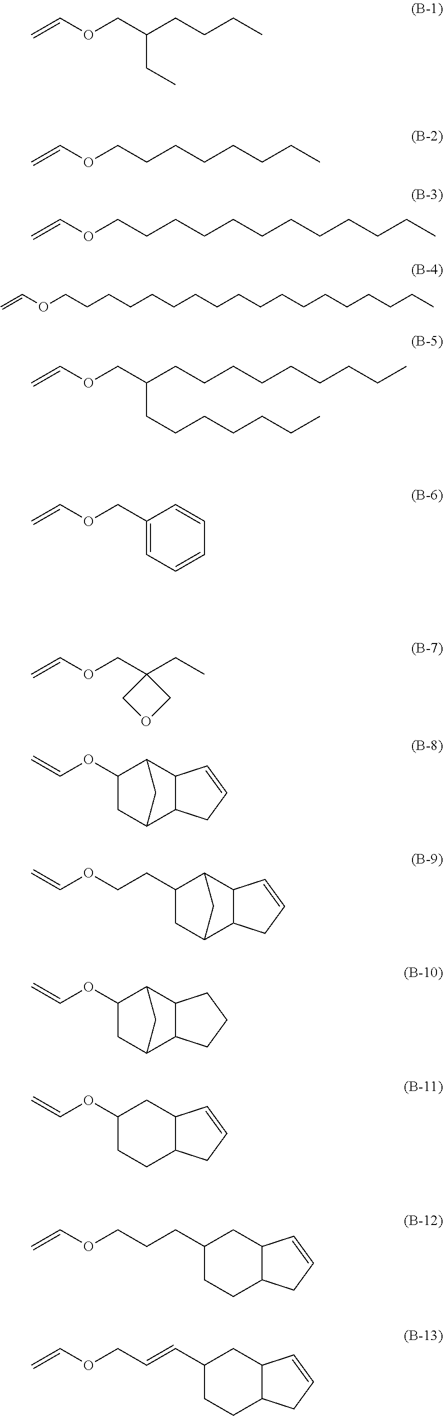

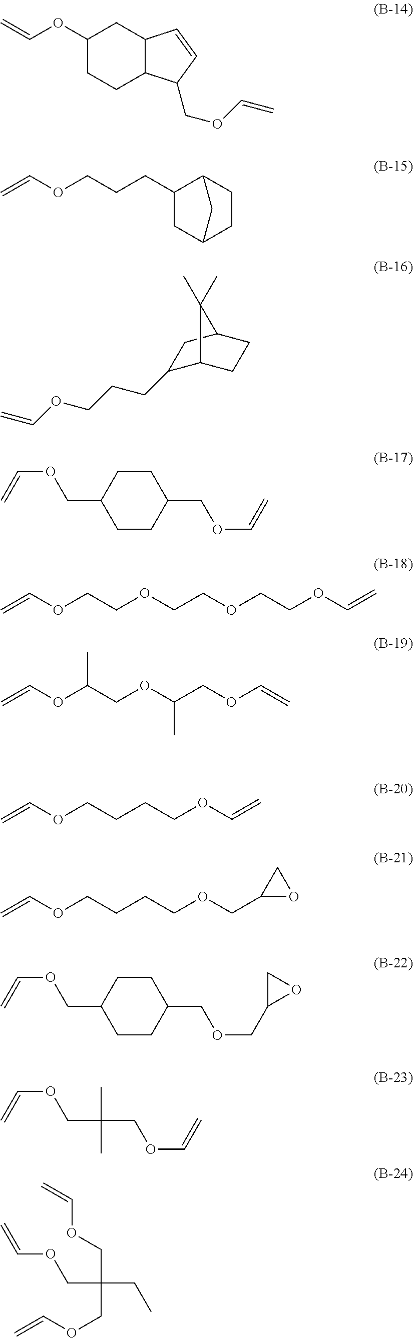

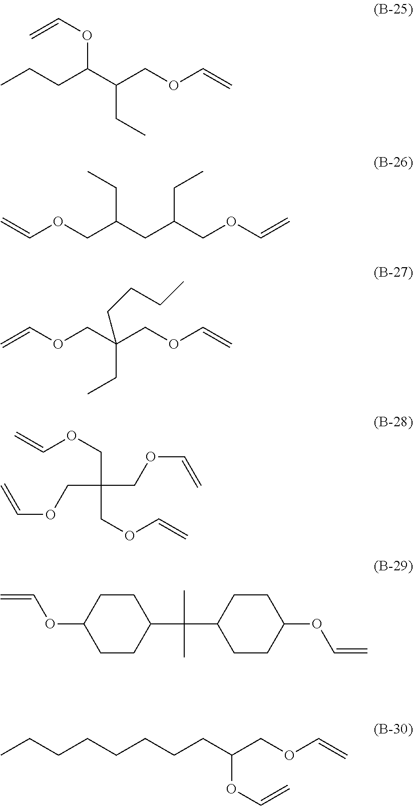

One kind of the vinyl ether compounds can be used, or two or more kinds thereof can be used in combination.

Of the vinyl ether compounds, the following compounds are preferred: cyclohexanedimethanol divinyl ether (B-17), neopentyl glycol divinyl ether (B-23), trimethylolpropane trivinyl ether (B-24), 2-ethyl-1,3-hexanediol divinyl ether (B-25), 2,4-diethyl-1,5-pentanediol divinyl ether (B-26), 2-butyl-2-ethyl-1,3-propanediol divinyl ether (B-27), pentaerythritol tetravinyl ether (B-28), and 1,2-decanediol divinyl ether (B-30). Those vinyl ether compounds each show excellent curability when irradiated with UV light because the compounds each have a plurality of vinyl ether groups in one molecule thereof. Further, the compounds are each free of any carbon-carbon double bond except in a vinyl ether structure, and hence the bias of an electron density in a molecule of each of the compounds is suppressed and a high volume resistivity is easily obtained.

The vinyl ether compound is a main component for the UV-curable liquid developer or UV-curable composition of the present invention. The content of the vinyl ether compound is preferably 90 parts by mass or more and 99.9 parts by mass or less, more preferably 95 parts by mass or more and 99.9 parts by mass or less with respect to 100 parts by mass of the UV-curable liquid developer or the UV-curable composition.

In addition, in the UV-curable liquid developer or UV-curable composition of the present invention, a high-molecular weight body can be incorporated into the vinyl ether compound.

In consideration of its compatibility with the vinyl ether compound, the high-molecular weight body preferably has a weight-average molecular weight of 10,000 or less.

As in the vinyl ether compound, such high-molecular weight body is preferably a high-molecular weight body of a structure that does not reduce the electric resistance of the developer or the composition. Specifically, the high-molecular weight body is preferably a compound free of any heteroatom or a structure free of any carbon-carbon double bond except in a vinyl ether group.

Of such high-molecular weight bodies, a structure having a vinyl ether group at a terminal thereof is particularly preferred in terms of curability because the structure can crosslink with the vinyl ether monomer to cure. Specific examples [Exemplified Compounds B-31 to B-36] of such compound having a vinyl ether group are given below.

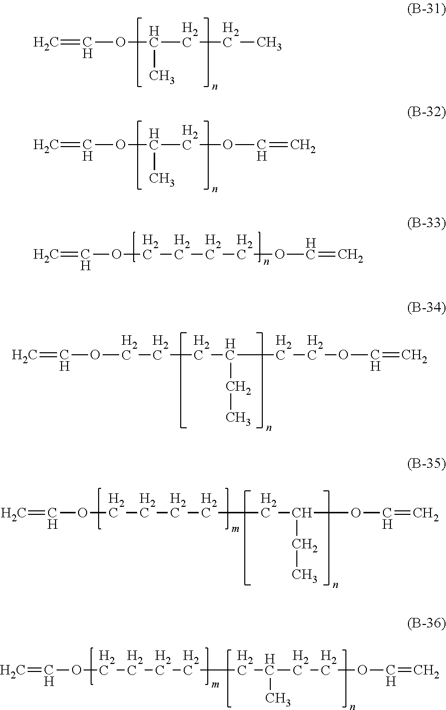

(In the respective formulae, m and n each independently represent such an integer of 0 or more that the weight-average molecular weight of each of the compounds represented by the respective formulae becomes 1,000 or more and 10,000 or less.)

Such high-molecular weight body having a vinyl ether group at a terminal thereof is incorporated in an amount of preferably 1 part by mass or more and 100 parts by mass or less, more preferably 5 parts by mass or more and 50 parts by mass or less with respect to 100 parts by mass of the vinyl ether monomer in the UV-curable liquid developer or the UV-curable composition.

[Sensitizer]

The UV-curable liquid developer or UV-curable composition of the present invention contains the sensitizer for the purpose of, for example, improving the efficiency with which a photo-acid generator generates an acid or lengthening the photosensitive wavelength of the photopolymerization initiator.

The sensitizer sensitizes the photopolymerization initiator via an electron transfer mechanism or an energy transfer mechanism, and a particularly preferred mode in the present invention is as follows: the sensitizer is a material that expresses a sensitizing action with light having a wavelength of 360 nm or more and 390 nm or less (UV light). That is, the sensitizer is preferably a material that has absorption in the wavelength region of from 360 nm or more to 390 nm or less, and that is free of any absorption for visible light, e.g., light having a wavelength of 400 nm or more. The phrase “free of any absorption” as used in the present invention means that an absorbance at the designated wavelength is 0.01 or less.

The sensitizer that can be used in the present invention is a compound represented by the following formula (1).

X—Y (1)

In the formula (1): X represents one functional group selected from the group consisting of a triphenylenyl group, a phenanthrenyl group, a pyrenyl group, a fluoranthenyl group, a fluorenyl group, a chrysenyl group, a carbazolyl group, a dibenzofuranyl group, a dibenzothiophenyl group, and a naphthyl group; and Y represents one functional group selected from the group consisting of a triphenylenyl group, a phenanthrenyl group, a pyrenyl group, a fluoranthenyl group, a fluorenyl group, a chrysenyl group, a carbazolyl group, a dibenzofuranyl group, a dibenzothiophenyl group, a naphthyl group, a phenyl group, a biphenyl group, and a terphenyl group.

In the formula (1), a carbon atom forming X and a carbon atom forming Y are directly bonded to each other without through a carbon atom or any other atom therebetween.

The X and Y may each independently have a substituent selected from the group consisting of an alkyl group, a perfluoroalkyl group, a cycloalkyl group, an alkenyl group, a cycloalkenyl group, an alkoxy group, an alkylthio group, a hydroxy group, a halogen atom, a cyano group, a carbonyl group, a carboxy group, an oxycarbonyl group, a carbamoyl group, an amino group, a silyl group, a nitro group, and a sulfonic group.

Specific examples [Exemplified Compounds C-1 to C-136] of the sensitizer are given below.

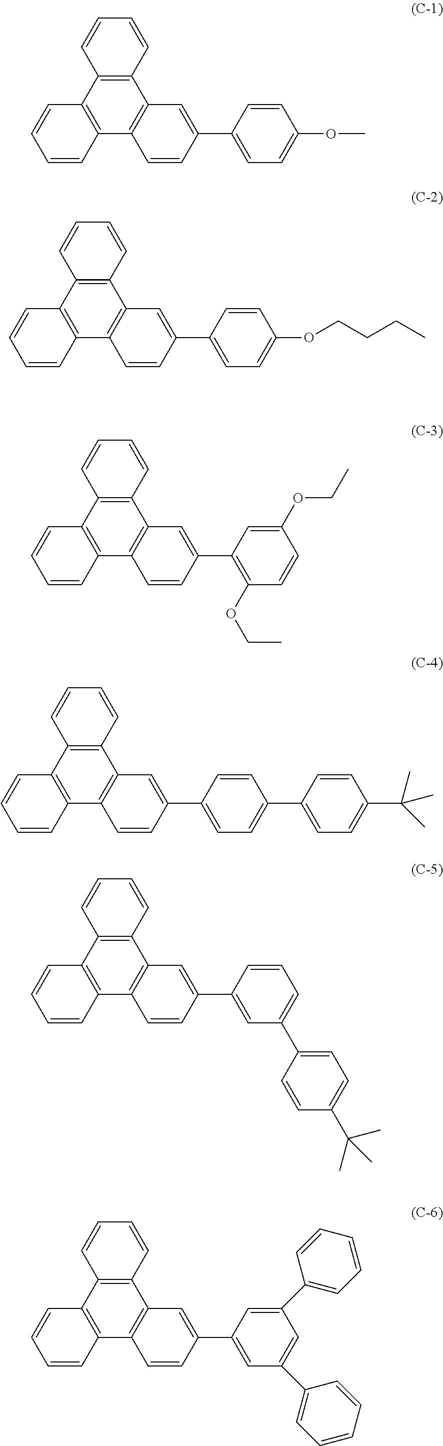

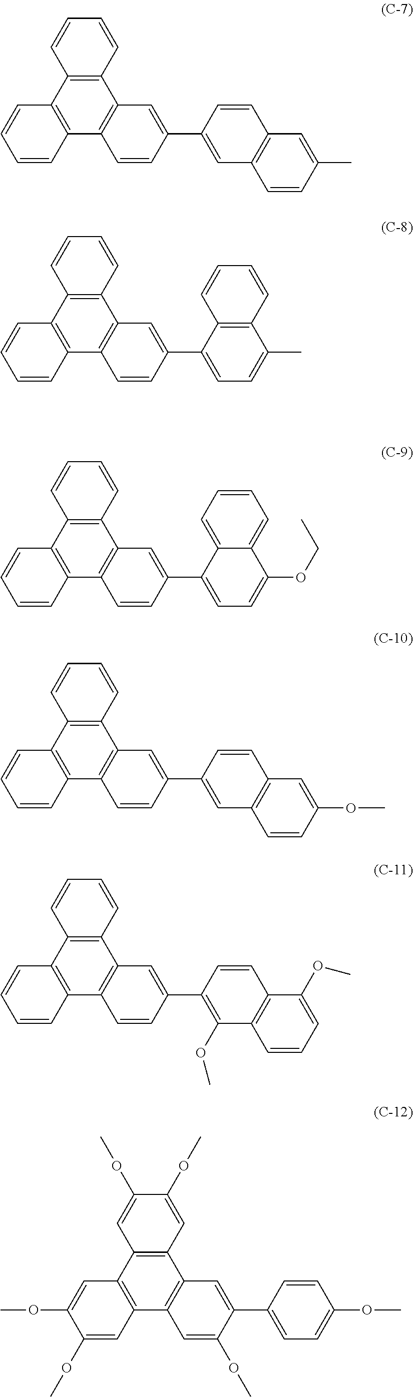

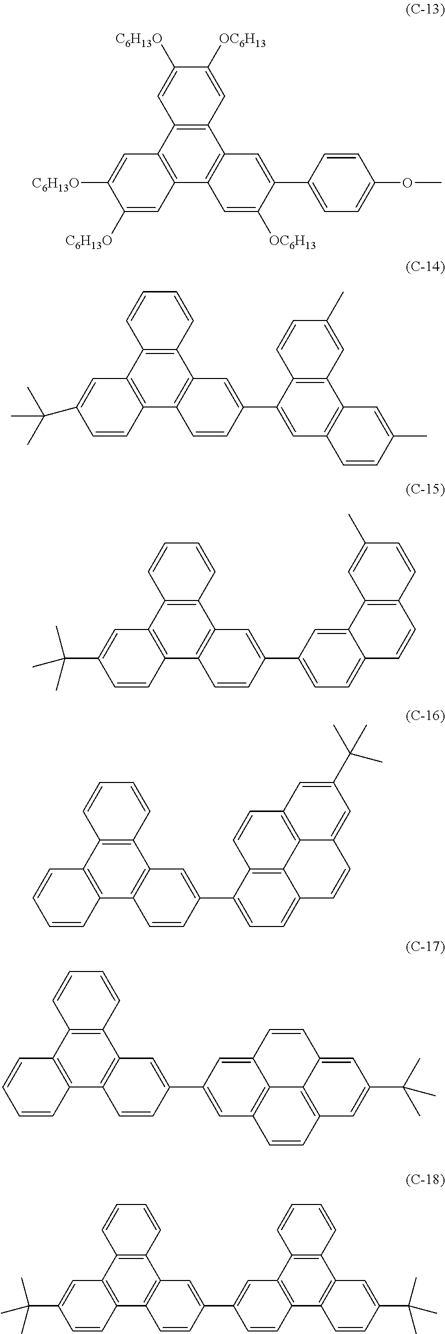

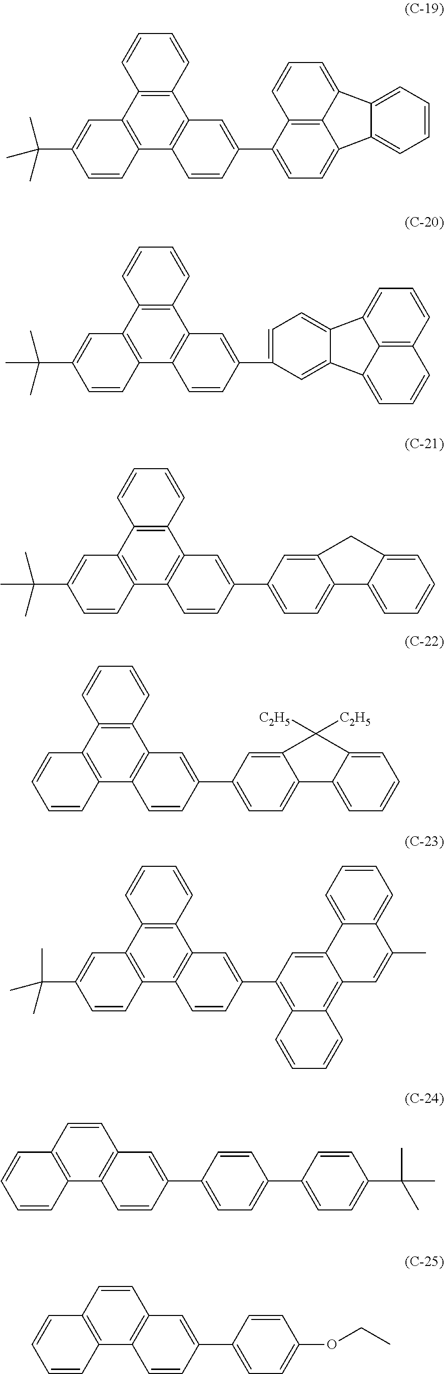

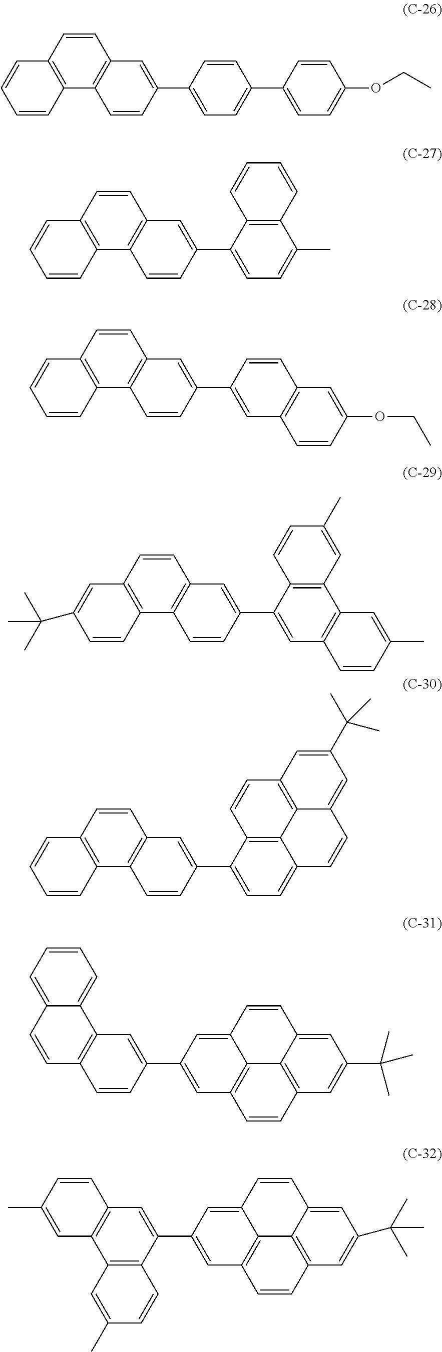

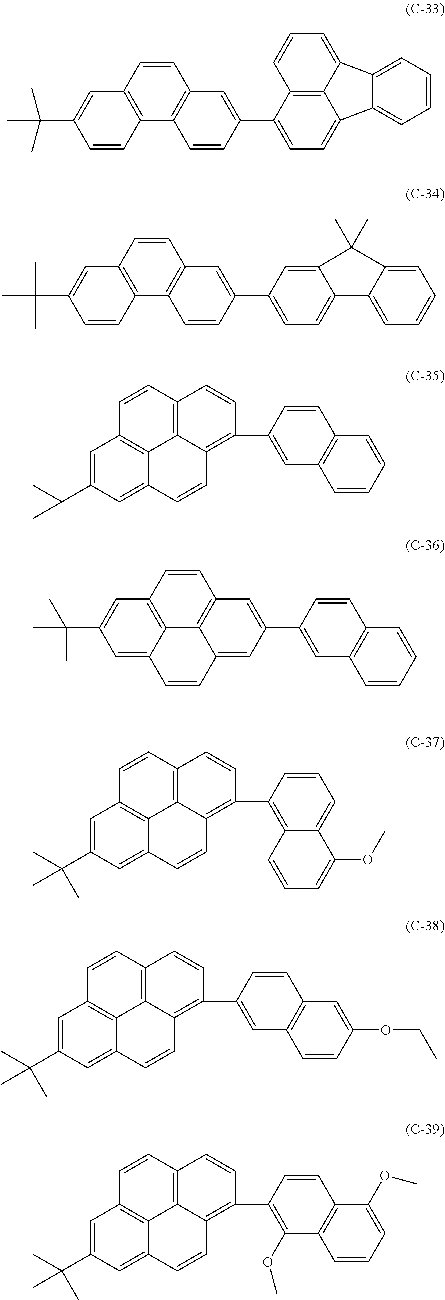

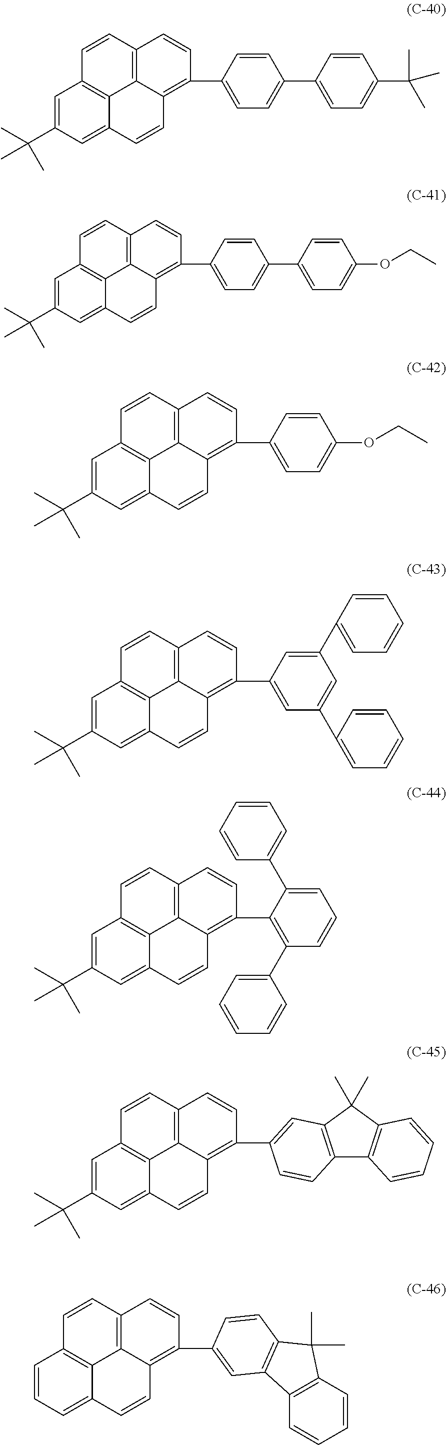

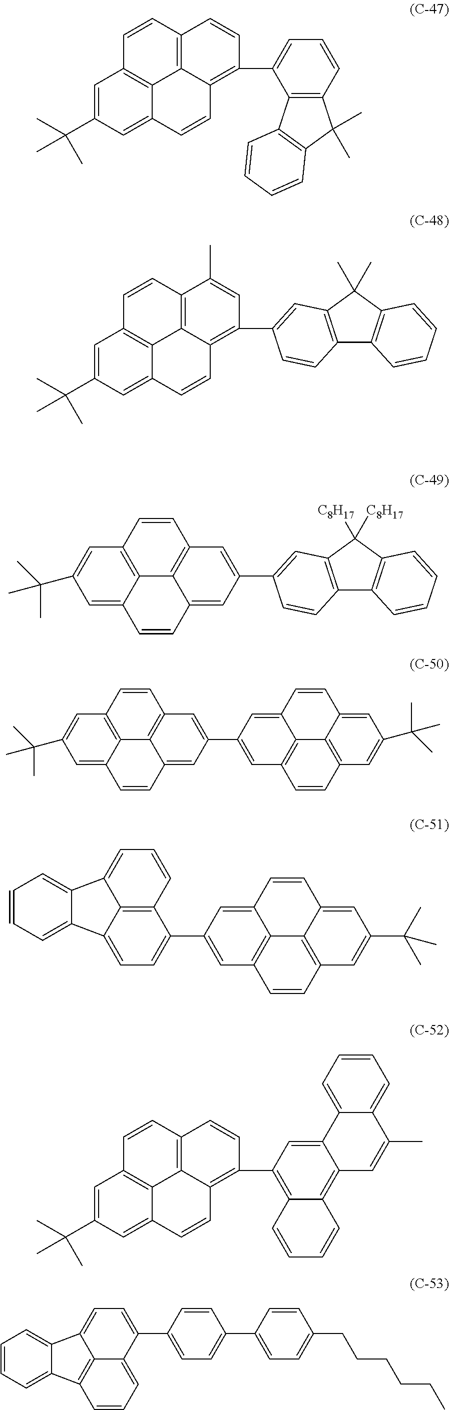

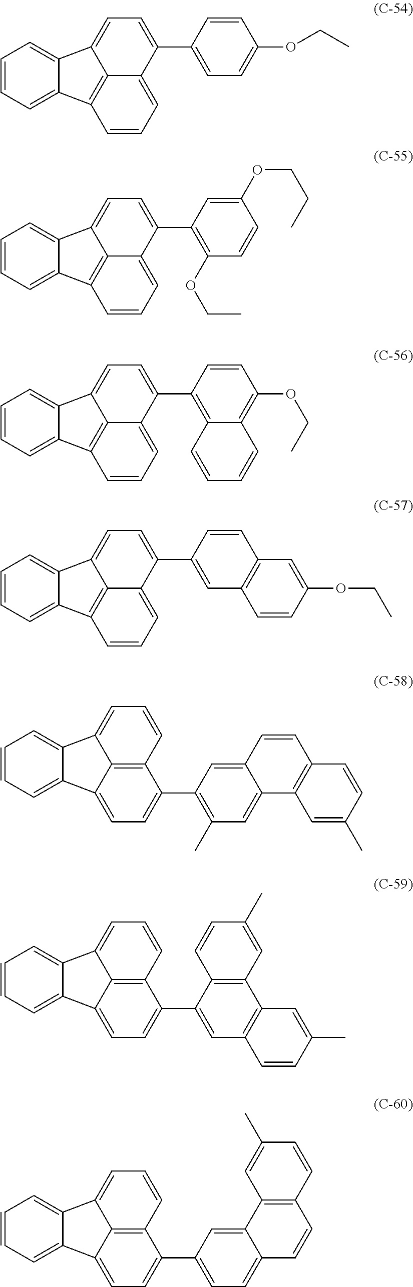

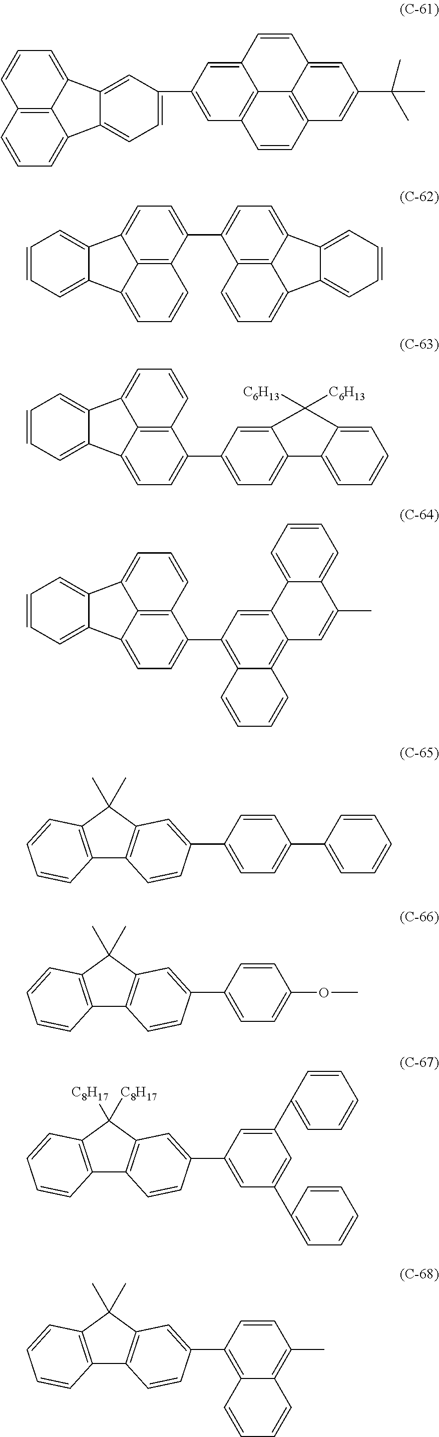

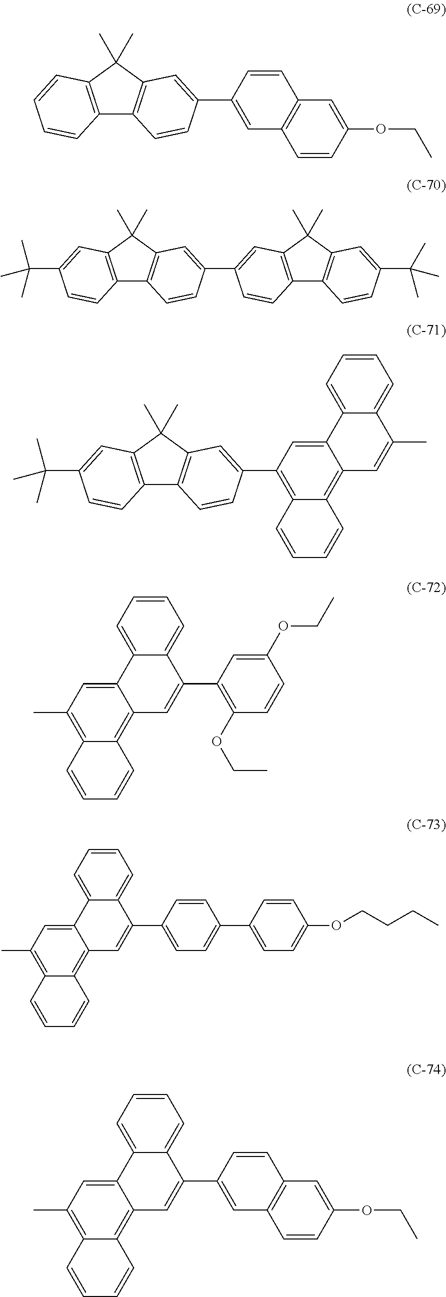

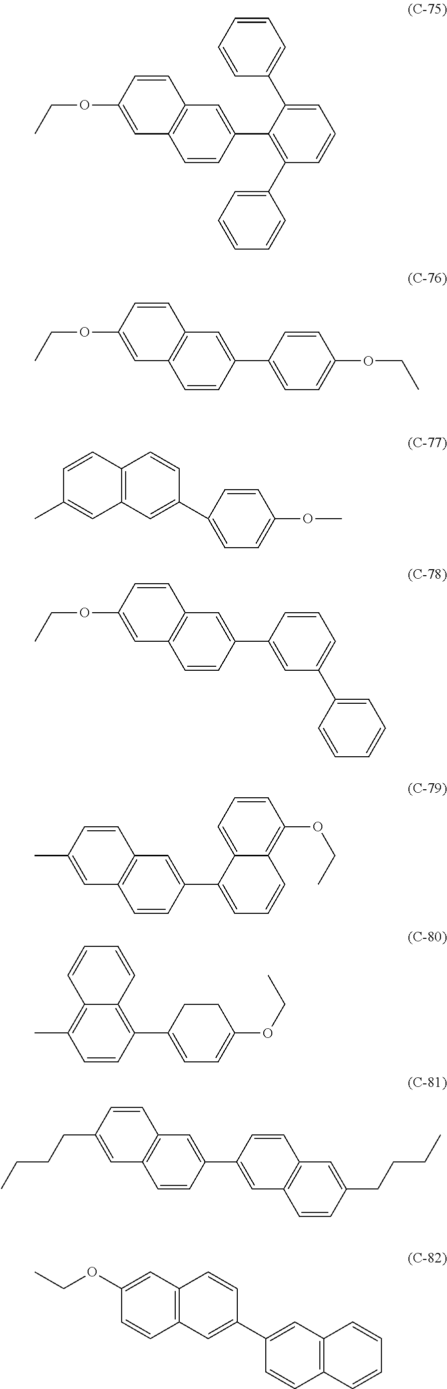

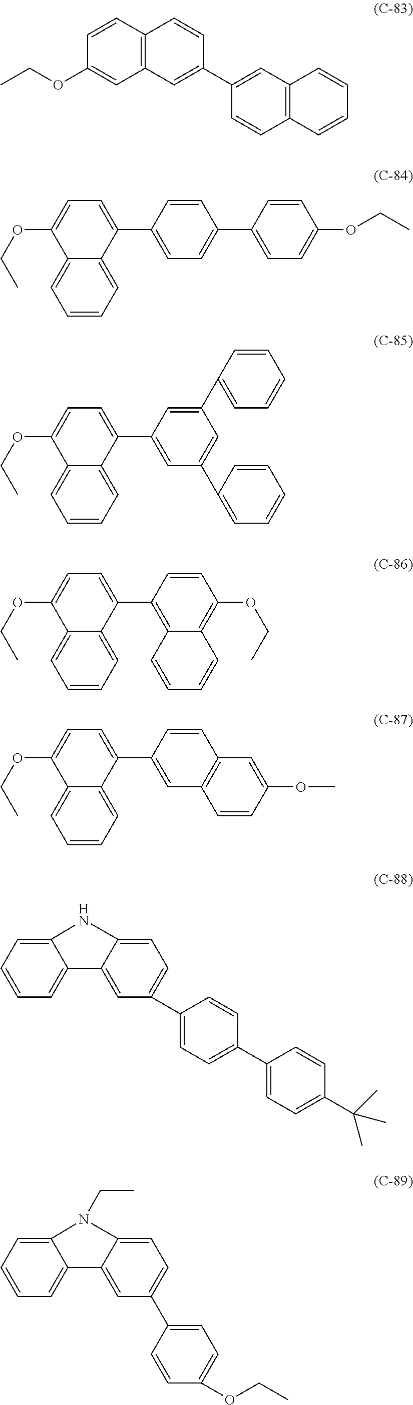

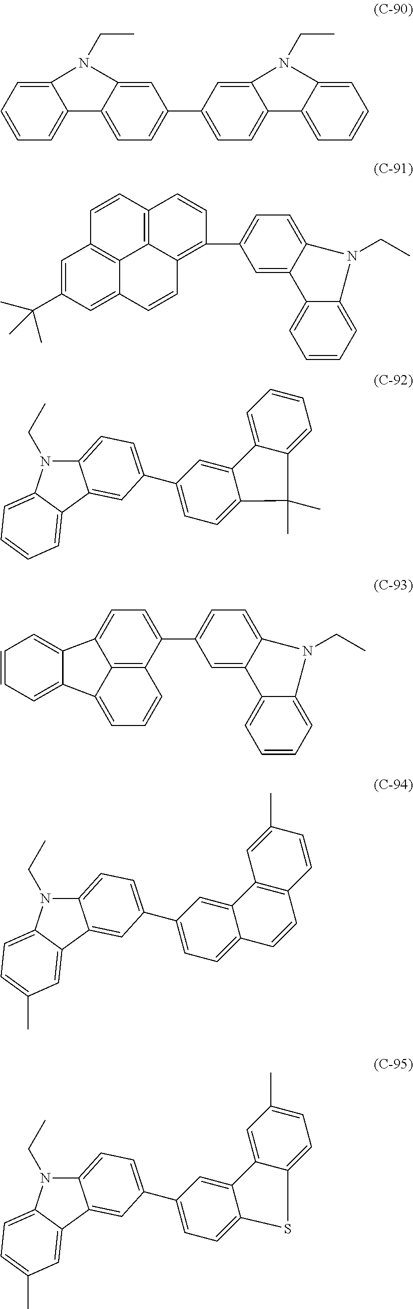

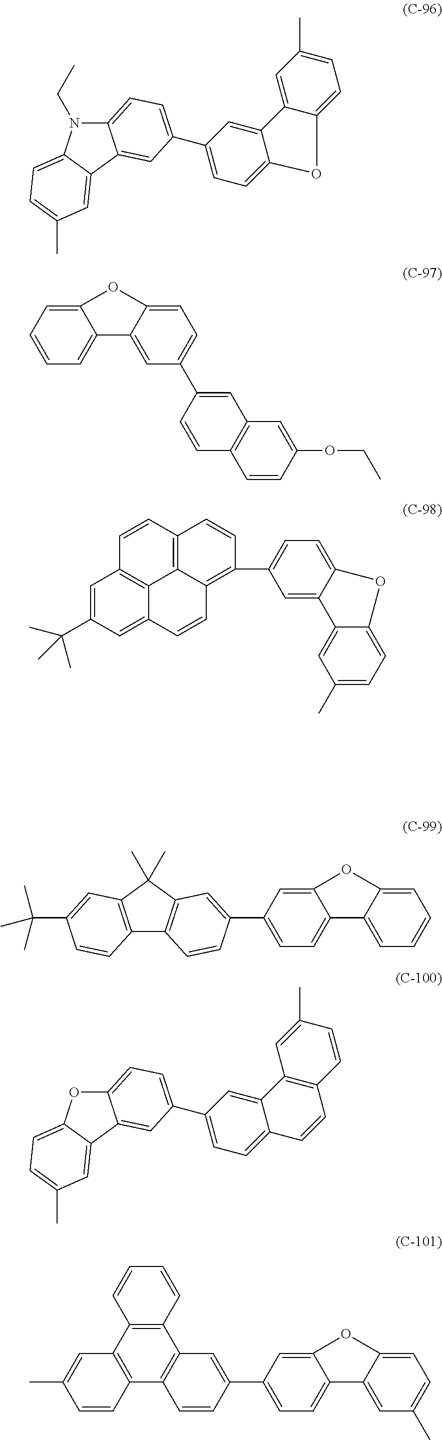

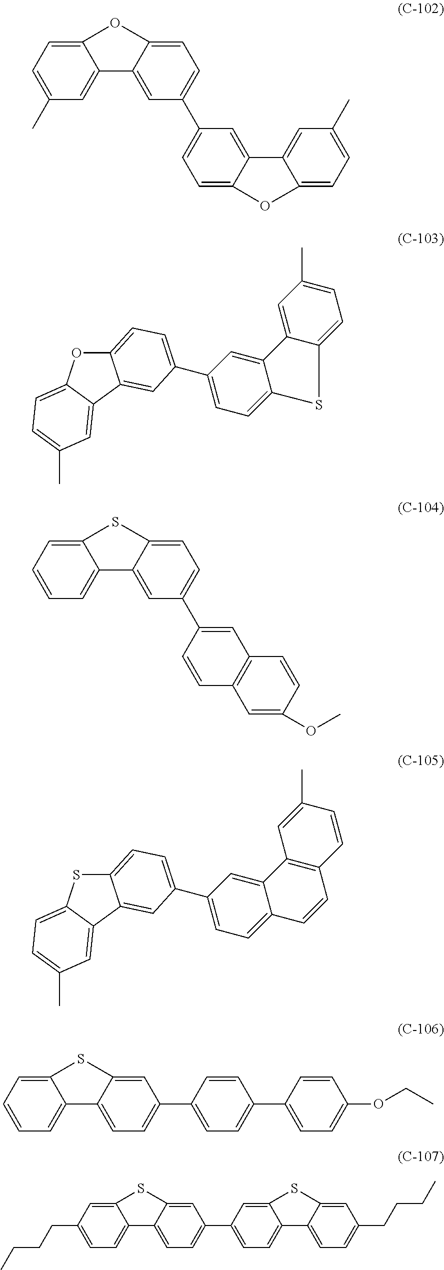

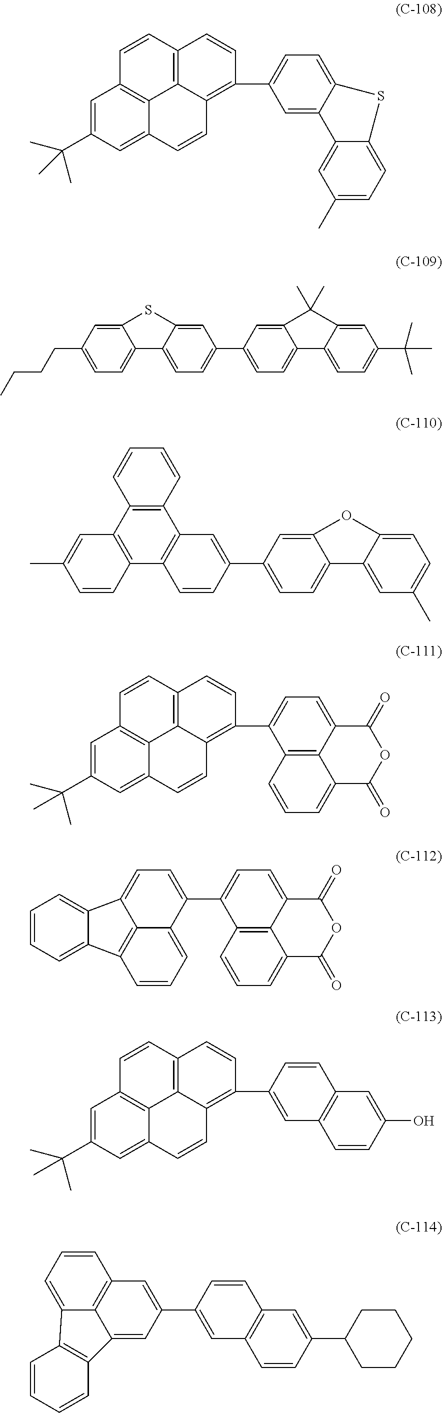

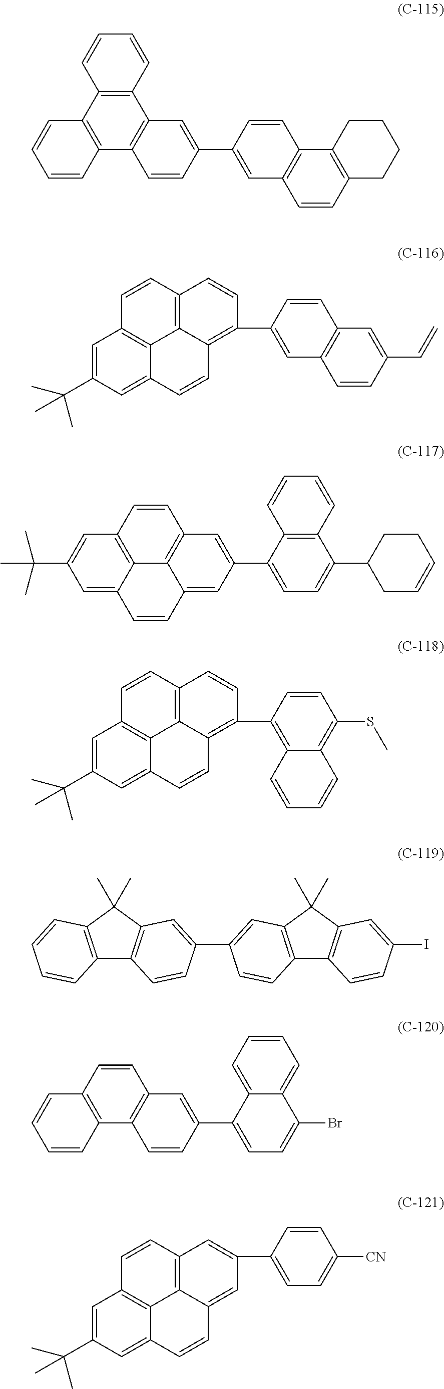

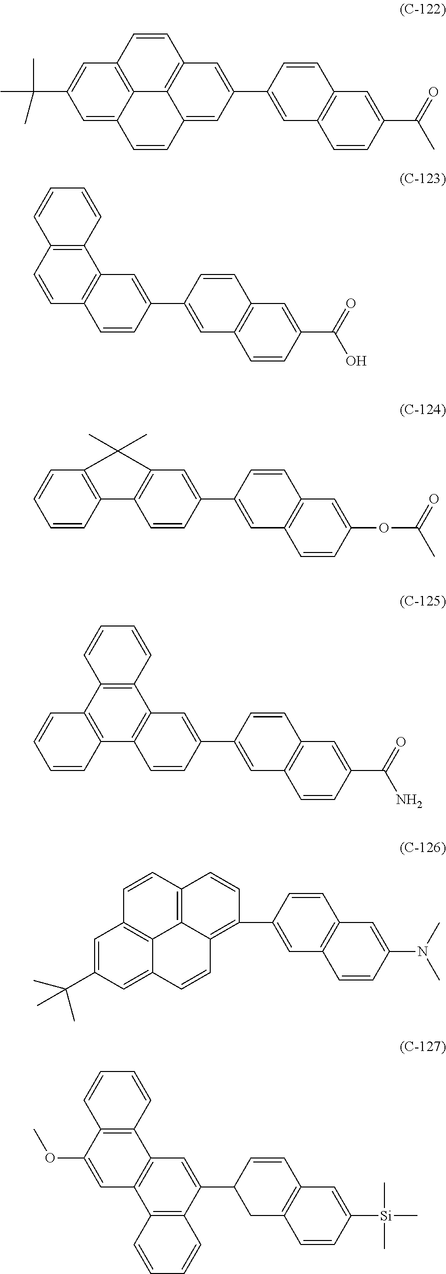

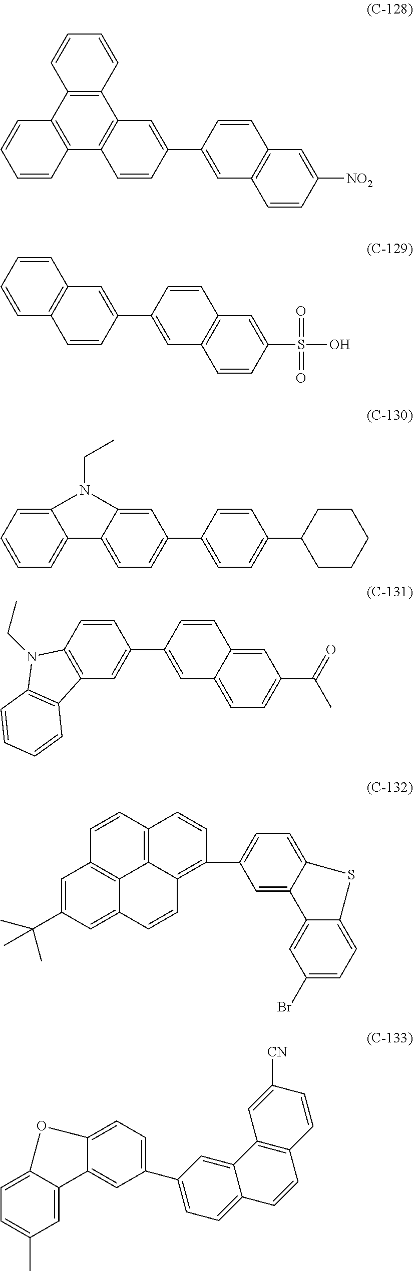

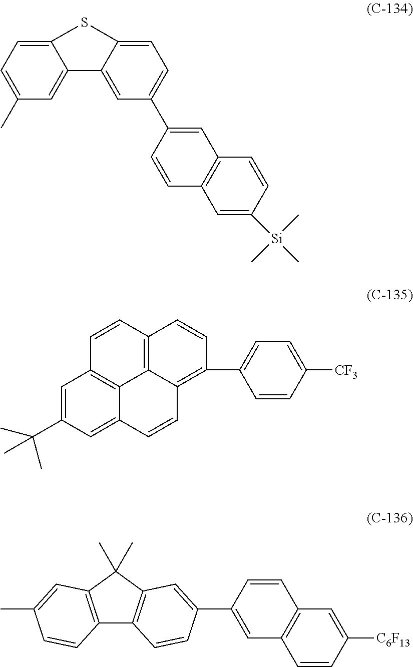

As a method of adjusting the absorption wavelength of the compound represented by the formula (1) in the sensitizer, the inventors of the present invention have paid attention to the number of carbon atoms each having an SP² hybrid orbital (hereinafter sometimes referred to as “SP² conjugations”) that are present in the conjugated system of the cyclic compound, and the orientations of the conjugations formed by the carbon atoms. Description is given by taking anthracene and naphthalene as examples. Anthracene is a compound having 14 continuous SP² conjugations in which 3 benzene rings are condensed in a linear direction. The absorption wavelength of anthracene has an absorption edge at about 380 nm and has an absorption peak at about 375 nm. Meanwhile, naphthalene is a compound having a structure in which 2 benzene rings are condensed in a linear direction, and having 10 continuous SP² conjugations. The absorption wavelength of naphthalene has an absorption edge at about 320 nm and has an absorption peak at about 285 nm. When a functional group is added to anthracene in which 3 or more conjugations in terms of a benzene ring lie in a row in the linear direction as described above, anthracene has absorption at a wavelength of 400 nm or more, and hence anthracene is considered to be unsuitable as the sensitizer of a liquid developer predicated on the fact that an electrophotographic image forming apparatus may be opened for the purpose of its maintenance like the present invention. In actuality, 9,10-diethoxyanthracene known as a general sensitizer has an absorption edge at about 430 nm and has absorption in the visible light region. Meanwhile, a compound having a structure in which 2 or less conjugations in terms of a benzene ring lay in a row had an absorption edge at a wavelength of 350 nm or less. Here, the phrase “condensed in a linear direction” refers to the following structure. That is, in the case where 3 aromatic rings are continuously condensed, the phrase refers to a structure in which when one carbon-carbon bond of a six-membered aromatic ring, such as a benzene ring, is condensed with another benzene ring, the remaining aromatic ring is condensed with a carbon-carbon bond directly opposite to the above-mentioned carbon-carbon bond. Accordingly, phenanthrene, pyrene, or the like is not a compound in which benzene rings are condensed in a linear direction unlike anthracene, and hence 2 benzene rings can be considered to be condensed in the linear direction. The inventors have found that when 2 or more unit structures in each of which 2 benzene rings are condensed in a linear direction as described above are combined, the resultant combination has absorption at an appropriate wavelength, e.g., a wavelength of 360 nm or more and 390 nm or less, and is free of any absorption at a wavelength of 400 nm or more. Thus, the inventors have reached the present invention.

X and Y in the formula (1) may each have a substituent for improving compatibility between any other component in the UV-curable liquid developer, such as the polymerizable monomer or the initiator, and the sensitizer. Examples of the substituent include an alkyl group, a perfluoroalkyl group, a cycloalkyl group, an alkenyl group, a cycloalkenyl group, an alkoxy group, an alkylthio group, a hydroxy group, a halogen atom, a cyano group, a carbonyl group, a carboxy group, an oxycarbonyl group, a carbamoyl group, an amino group, a silyl group, a nitro group, and a sulfonic group.

Specific examples of the alkyl group serving as the substituent include a methyl group, an ethyl group, a propyl group, a butyl group, a pentyl group, a hexyl group, a heptyl group, an octyl group, a decyl group, and a dodecyl group.

Specific examples of the fluoroalkyl group serving as the substituent include a trifluoromethyl group, a pentafluoroethyl group, a heptafluoropropyl group, a nonafluorobutyl group, an undecafluoropentyl group, and a tridecafluorohexyl group.

Specific examples of the cycloalkyl group serving as the substituent include a cyclopropyl group, a cyclobutyl group, a cyclopentyl group, a cyclohexyl group, a cycloheptyl group, a cyclooctyl group, a cyclodecyl group, and a cyclododecyl group.

Specific examples of the alkenyl group serving as the substituent include a vinyl group, a propenyl group, a butenyl group, a pentenyl group, a hexenyl group, a heptenyl group, an octenyl group, a decenyl group, and a dodecenyl group.

Specific examples of the cycloalkenyl group serving as the substituent include a cyclopropenyl group, a cyclobutenyl group, a cyclopentenyl group, a cyclohexenyl group, a cycloheptenyl group, a cyclooctenyl group, a cyclodecenyl group, and a cyclododecenyl group.

A specific example of the alkoxy group serving as the substituent is a group obtained by bonding the alkyl group, the cycloalkyl group, the alkenyl group, or the cycloalkenyl group to X or Y through an oxygen atom.

A specific example of the alkylthio group serving as the substituent is a group obtained by bonding the alkyl group, the cycloalkyl group, the alkenyl group, or the cycloalkenyl group to X or Y through a sulfur atom.

Specific examples of the halogen atom serving as the substituent include a fluorine atom, a chlorine atom, a bromine atom, and an iodine atom.

A specific example of the carbonyl group serving as the substituent is a group obtained by bonding a hydrogen atom, the alkyl group, the cycloalkyl group, the alkenyl group, or the cycloalkenyl group to X or Y through carbonyl (CO).

A specific example of the oxycarbonyl group serving as the substituent is a group obtained by bonding the alkoxy group to X or Y through carbonyl (CO).

A specific example of the carbamoyl group serving as the substituent is a group obtained by bonding the alkyl group, the cycloalkyl group, the alkenyl group, or the cycloalkenyl group to X or Y through a carbamoyl bond (NCOO). In this case, any one of N and O of the carbamoyl bond may be bonded to X or Y.

A specific example of the amino group serving as the substituent is a group obtained by simultaneously or separately bonding one or two of hydrogen atoms, the alkyl groups, the cycloalkyl groups, the alkenyl groups, or the cycloalkenyl groups to X or Y through a nitrogen atom.

An example of the silyl group serving as the substituent is a group obtained by simultaneously or separately bonding one or more and three or less of hydrogen atoms, the alkyl groups, the cycloalkyl groups, the alkenyl groups, or the cycloalkenyl groups to X or Y through a silicon atom.

Of those, a material hardly causing curing inhibition due to moisture is preferred when the curability of the developer by cationic polymerization is considered, and even when the sensitizer is incorporated in a trace amount, the sensitizer is preferably a material hardly adsorbing a water molecule.

From those viewpoints, the substituent of each of X and Y is preferably an alkyl group or an alkoxy group having 1 or more and 8 or less carbon atoms. The alkyl group or the alkoxy group may be linear or may be of a branched structure.

In addition, in order that the developability in the liquid developer may be improved, the liquid itself is preferably provided with a high resistance. Further, the sensitizer is preferably a sensitizer that does not cause any reduction in volume resistivity of the developer when incorporated thereinto. The sensitizer is preferably a material having the following characteristic: the bias of an electron density in a ring forming the sensitizer hardly occurs and hence an electrostatic interaction hardly acts between the molecules of the sensitizer. That is, the ring forming the sensitizer is preferably an aliphatic or aromatic ring free of any heteroatom in itself. Here, the term “heteroatom” refers to an atom except a carbon atom and a hydrogen atom.

A ring structure for forming X and Y is preferably a triphenylenyl group, a phenanthrenyl group, a pyrenyl group, a fluoranthenyl group, a fluorenyl group, a chrysenyl group, a naphthyl group, a phenyl group, a biphenyl group, or a terphenyl group. When any such ring structure is used, the bias of an electron density in the ring structure is suppressed and hence a high electric resistance is easily obtained.

The content of the sensitizer of the present invention is preferably 0.01 part by mass or more and 5 parts by mass or less, more preferably 0.05 part by mass or more and 5 parts by mass or less, still more preferably 0.1 part by mass or more and 1 part by mass or less with respect to 100 parts by mass of the UV-curable liquid developer or UV-curable composition of the present invention. One kind of the sensitizers can be incorporated, or two or more kinds thereof can be incorporated in combination.

In addition, a sensitizing aid is preferably further incorporated into the UV-curable liquid developer or UV-curable composition of the present invention for the purpose of improving energy transfer efficiency between the sensitizer and the photopolymerization initiator. Specific examples of the sensitizing aid include: naphthalene compounds, such as 1,4-dihydroxynaphthalene, 1,4-dimethoxynaphthalene, 1,4-diethoxynaphthalene, 4-methoxy-1-naphthol, and 4-ethoxy-1-naphthol; and benzene compounds, such as 1,4-dihydroxybenzene, 1,4-dimethoxybenzene, 1,4-diethoxybenzene, 1-methoxy-4-phenol, and 1-ethoxy-4-phenol.

The content of the sensitizing aid is preferably 0.01 part by mass or more and 5 parts by mass or less, more preferably 0.05 part by mass or more and 5 parts by mass or less, still more preferably 0.1 part by mass or more and 1 part by mass or less with respect to 100 parts by mass of the UV-curable liquid developer or UV-curable composition of the present invention. One kind of the sensitizing aids can be incorporated, or two or more kinds thereof can be incorporated in combination.

[Toner Particles]

The UV-curable liquid developer of the present invention contains the toner particles insoluble in the polymerizable monomer. The toner particles each contain a binder resin and a pigment. A charge director may be incorporated into the UV-curable liquid developer as required.

A method of producing the toner particles is, for example, a method such as a coacervation method or a wet pulverization method.

Details about the coacervation method are described in, for example, International Publication No. WO2007/000974 and International Publication No. WO2007/000975. In addition, details about the wet pulverization method are described in, for example, International Publication No. WO2006/126566 and International Publication No. WO2007/108485. Any such method can be utilized in the present invention.

The number-average particle diameter of the toner particles obtained by any such method is preferably 0.05 μm or more and 5 μm or less, more preferably 0.05 μm or more and 1 μm or less from the viewpoint that a high-definition image is obtained.

The UV-curable liquid developer of the present invention is obtained by mixing such toner particles and the UV-curable composition of the present invention. The toner particles are preferably used in an amount of 1 part by mass or more and 100 parts by mass or less with respect to 100 parts by mass of the UV-curable composition.

Binder Resin

A binder resin having fixability to an adherend, such as paper or a plastic film, can be used as the binder resin to be incorporated into each of the toner particles. Examples of the binder resin that can be used include resins such as an epoxy resin, an ester resin, an acrylic resin, a styrene-acrylic resin, an alkyd resin, a polyethylene resin, an ethylene-acrylic resin, and a rosin-modified resin. As required, one kind of those resins can be used alone, or two or more kinds thereof can be used in combination.

The content of the binder resin is preferably 50 parts by mass or more and 1,000 parts by mass or less with respect to 100 parts by mass of the pigment described below.

Pigment

Various organic pigments and inorganic pigments, a product obtained by dispersing a pigment in an insoluble resin or the like serving as a dispersion medium, a product obtained by grafting a resin to the surface of a pigment, and the like can each be used as the pigment to be incorporated into each of the toner particles.

The pigment is, for example, a pigment described in W. Herbst, K. Hunger “Industrial Organic Pigments.”

Specific examples of the organic pigment and the inorganic pigment that can be used in the present invention include the following pigments. As a yellow coloring pigment, there are given, for example: C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, or 185; and C.I. Vat Yellow 1, 3, or 20.

As a red or magenta coloring pigment, there are given, for example: C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, or 269; C.I. Pigment Violet 19; and C.I. Vat Red 1, 2, 10, 13, 15, 23, 29, or 35.

As a blue or cyan coloring pigment, there are given, for example: C.I. Pigment Blue 2, 3, 15:2, 15:3, 15:4, 16, or 17; C.I. Vat Blue 6; C.I. Acid Blue 45; and a copper phthalocyanine pigment in which a phthalocyanine skeleton is substituted by 1 or more and 5 or less phthalimidomethyl groups.

As a green coloring pigment, there is given, for example, C.I. Pigment Green 7, 8, or 36.

As an orange coloring pigment, there is given, for example, C.I. Pigment Orange 66 or 51.

As a black coloring pigment, there are given, for example, carbon black, titanium black, and aniline black.

A white pigment is specifically exemplified by basic lead carbonate, zinc oxide, titanium oxide, and strontium titanate. Here, titanium oxide has a small specific gravity, has a large refractive index, and is chemically and physically stable as compared to any other white pigment. Accordingly, titanium oxide has a large hiding power and a large coloring power as a pigment, and is excellent in durability against an acid, an alkali, and other environments. Therefore, titanium oxide is preferably utilized as the white pigment. Other white pigments (that may be pigments except the listed white pigments) may be used as required.

Dispersing means in accordance with the method of producing the toner particles needs only to be used in the dispersion of the pigment in each of the toner particles. For example, a ball mill, a sand mill, an attritor, a roll mill, a jet mill, a homogenizer, a paint shaker, a kneader, an agitator, a Henschel mixer, a colloid mill, an ultrasonic homogenizer, a pearl mill, and a wet jet mill are each given as an apparatus that can be used as the dispersing means.

A dispersant can be added when the dispersion of the pigment is performed. Examples of the dispersant can include a hydroxy group-containing carboxylate, a salt of a long-chain polyaminoamide and a high-molecular weight acid ester, a salt of a high-molecular weight polycarboxylic acid, a high-molecular weight unsaturated acid ester, a high-molecular weight copolymerized product, a modified polyacrylate, an aliphatic polycarboxylic acid, a naphthalenesulfonic acid formalin condensate, a polyoxyethylene alkyl phosphate, and a pigment derivative. Commercial polymer dispersants, such as Solsperse series manufactured by Lubrizol, are also preferably used.

In addition, synergists corresponding to various pigments can each be used as a dispersing aid. Any such dispersant and any such dispersing aid are preferably incorporated in an amount of 1 part by mass or more and 50 parts by mass or less with respect to 100 parts by mass of the pigment.

[Other Component]

The UV-curable liquid developer or UV-curable composition of the present invention can contain any one of the following additives as required.

Cationic Polymerization Inhibitor

A cationic polymerization inhibitor can also be incorporated into the UV-curable liquid developer or UV-curable composition of the present invention.

Examples of the cationic polymerization inhibitor can include alkali metal compounds and/or alkaline earth metal compounds, and amines.

Preferred examples of the amines include alkanolamines, N,N-dimethylalkylamines, N,N-dimethylalkenylamines, and N,N-dimethylalkynylamines. Specific examples thereof include triethanolamine, triisopropanolamine, tributanolamine, N-ethyldiethanolamine, propanolamine, n-butylamine, sec-butylamine, 2-aminoethanol, 2-methylaminoethanol, 3-methylamino-1-propanol, 3-methylamino-1,2-propanediol, 2-ethylaminoethanol, 4-ethylamino-1-butanol, 4-(n-butylamino)-1-butanol, 2-(t-butylamino)ethanol, N,N-dimethylundecanol, N,N-dimethyldodecanolamine, N,N-dimethyltridecanolamine, N,N-dimethyltetradecanolamine, N,N-dimethylpentadecanolamine, N,N-dimethylnonadecylamine, N,N-dimethylicosylamine, N,N-dimethyleicosylamine, N,N-dimethylhenicosylamine, N,N-dimethyldocosylamine, N,N-dimethyltricosylamine, N,N-dimethyltetracosylamine, N,N-dimethylpentacosylamine, N,N-dimethylpentanolamine, N,N-dimethylhexanolamine, N,N-dimethylheptanolamine, N,N-dimethyloctanolamine, N,N-dimethylnonanolamine, N,N-dimethyldecanolamine, N,N-dimethylnonylamine, N,N-dimethyldecylamine, N,N-dimethylundecylamine, N,N-dimethyldodecylamine, N,N-dimethyltridecylamine, N,N-dimethyltetradecylamine, N,N-dimethylpentadecylamine, N,N-dimethylhexadecylamine, N,N-dimethylheptadecylamine, and N,N-dimethyloctadecylamine. In addition, for example, a quaternary ammonium salt can also be used. Of those, a secondary amine is particularly preferred as the cationic polymerization inhibitor.

The content of the cationic polymerization inhibitor is preferably 1 ppm or more and 5,000 ppm or less with reference to the mass of the UV-curable liquid developer or the UV-curable composition.

Radical Polymerization Inhibitor

A radical polymerization inhibitor may be incorporated into the UV-curable liquid developer or UV-curable composition of the present invention.

The photopolymerization initiator decomposes to an extremely slight extent during the storage of the UV-curable liquid developer containing the polymerizable monomer over time to turn into a radical compound, and polymerization is caused by the radical compound in some cases. The radical polymerization inhibitor is preferably incorporated into the UV-curable liquid developer for suppressing the polymerization caused by the radical compound.

Examples of the radical polymerization inhibitor that can be applied include phenol-based hydroxy group-containing compounds, quinones, such as metoquinone (hydroquinone monomethyl ether), hydroquinone, and 4-methoxy-1-naphthol, hindered amine-based antioxidants, 1,1-diphenyl-2-picrylhydrazyl free radical, N-oxyl free radical compounds, nitrogen-containing heterocyclic mercapto-based compounds, thioether-based antioxidants, hindered phenol-based antioxidants, ascorbic acids, zinc sulfate, thiocyanic acid salts, thiourea derivatives, various sugars, phosphoric acid-based antioxidants, nitrous acid salts, sulfurous acid salts, thiosulfuric acid salts, hydroxylamine derivatives, aromatic amines, phenylenediamines, imines, sulfonamides, urea derivatives, oximes, polycondensates of dicyandiamide and polyalkylenepolyamines, sulfur-containing compounds, such as phenothiazine, tetraazaannulene (TAA)-based complexing agents, and hindered amines.

Of those, phenols, N-oxyl free radical compounds, 1,1-diphenyl-2-picrylhydrazyl free radical, phenothiazine, quinones, and hindered amines are preferred from the viewpoint of the prevention of the thickening of the UV-curable liquid developer due to the polymerization of the polymerizable monomer, and the N-oxyl free radical compounds are particularly preferred.

The content of the radical polymerization inhibitor is preferably 1 ppm or more and 5,000 ppm or less with reference to the mass of the UV-curable liquid developer of the present invention.

Charge Director

A charge director may be incorporated into the UV-curable liquid developer or UV-curable composition of the present invention as required.

Specific examples of the charge director include: oils and fats, such as linseed oil and soybean oil; alkyd resins; halogen polymers; aromatic polycarboxylic acids; acidic group-containing water-soluble dyes; oxidative condensates of aromatic polyamines; metal soaps, such as cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate, and cobalt 2-ethylhexanoate; sulfonic acid metal salts, such as a petroleum-based sulfonic acid metal salt and a metal salt of a sulfosuccinic acid ester; phospholipids, such as lecithin; salicylic acid metal salts, such as a t-butylsalicylic acid metal complex; and polyvinylpyrrolidone resins, polyamide resins, sulfonic acid-containing resins, and hydroxybenzoic acid derivatives.

Further, any other additive can be incorporated into each of the toner particles as required in addition to the foregoing.

[Other Additives]

In addition to the above-mentioned materials, various additives can be used for the UV-curable liquid developer or UV-curable composition of the present invention for the purpose of improvement of its recording medium adaptability, storage stability, image stability, or the like. Examples of the additives include a surfactant, a lubricant, a filler, an antifoaming agent, a UV absorber, an antioxidant, a discoloration preventing agent, a fungicide, and a rust inhibitor.

[Physical Properties of UV-Curable Liquid Developer]

The UV-curable liquid developer of the present invention is preferably used after having been prepared so as to have the same physical property values as those of a general liquid developer. That is, the viscosity of the UV-curable liquid developer is preferably 0.5 mPa·s or more and 10 mPa·s or less at 25° C. when the concentration of the toner particles is 2 mass % from the viewpoint of obtaining appropriate electrophoretic mobility of the toner particles. In addition, the volume resistivity of the UV-curable liquid developer is preferably 1×10¹⁰ Ω·cm or more and 1×10¹³ Ω·cm or less in order that the potential of an electrostatic latent image may not be dropped. In the present invention, a UV-curable liquid developer satisfying the physical property values while obtaining high UV-curability can be prepared.

[Electrophotographic Image Forming Apparatus]

The UV-curable liquid developer of the present invention can be suitably used in an electrophotographic image forming apparatus of an electrophotographic system.

UV Light Source

Immediately after having been transferred onto a recording medium, the UV-curable liquid developer of the present invention is irradiated with UV light to cure. Thus, an image is fixed.

Here, a light source for irradiating the developer with the UV light is preferably a belt-shaped metal halide lamp, a cold-cathode tube, a hot-cathode tube, a mercury lamp, a black light, or a light emitting diode (LED).

The dose of the UV light is preferably 0.1 mJ/cm² or more and 1,000 mJ/cm² or less.

### EXAMPLES

Methods of producing the UV-curable liquid developer and UV-curable composition of the present invention are described more specifically below by way of Examples. In the following description, the terms “part(s)” and “%” mean “part(s) by mass” and “mass %”, respectively unless otherwise stated.

Typical synthesis examples of the sensitizer compound to be used in the present invention are described below.

### Synthesis Example 1

(Synthesis of Intermediate 1)

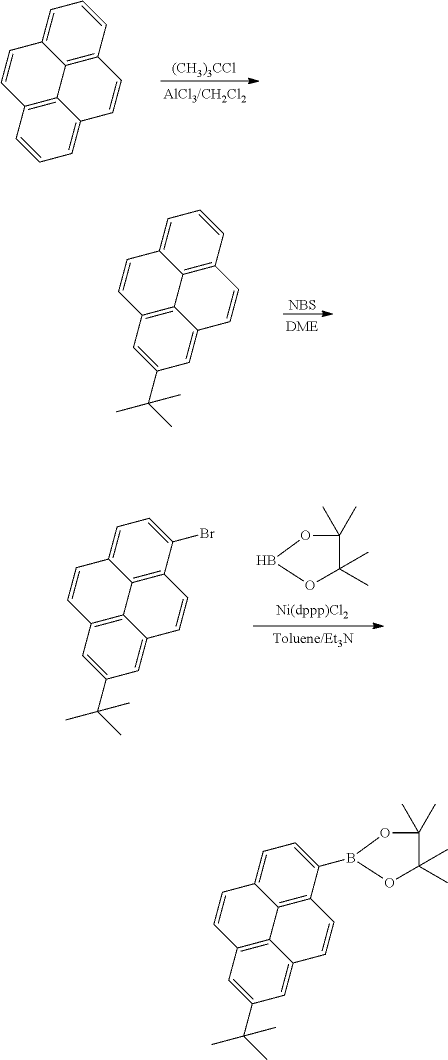

50.0 Grams (0.25 mol) of pyrene, 27.6 g (0.30 mol) of t-butyl chloride, and 200 ml of methylene chloride were loaded into a reaction vessel, and the mixture was cooled to 0° C. Next, 35.3 g (0.27 mol) of aluminum chloride was loaded into the mixture, and the whole was stirred at room temperature for 2 hours. Next, ice water and methylene chloride were added to the resultant, and an organic layer was extracted and washed with water. After that, the layer was dried with magnesium sulfate and recrystallized to provide a t-butylpyrene crystal in a yield of 33 g and a percentage yield of 51%.

Next, 25.0 g (0.10 mol) of t-butylpyrene and 250 ml of 1,2-dimethoxyethane (DME) were loaded into a reaction vessel, and the mixture was cooled to 0° C. Next, N-bromosuccinimide (NBS) was added in an amount of 4 equivalents with respect to t-butylpyrene to the mixture, and the whole was stirred at room temperature overnight. After that, the resultant was filtered and recrystallized to provide a bromo-t-butylpyrene crystal in a yield of 29.5 g and a percentage yield of 90%.

After that, under a nitrogen atmosphere, 27.0 g (0.08 mol) of bromo-t-butylpyrene, 26.0 g (0.20 mol) of 4,4,5,5-tetramethyl-1,2,3-dioxaborolane, 40.0 g (0.40 mol) of triethylamine, 3.5 g (6.45 mmol) of Ni(dppp)Cl₂, and 540 ml of toluene were loaded into a reaction vessel, and the mixture was stirred under heating at 100° C. After that, the mixture was cooled, and toluene and water were loaded into the mixture. After that, an organic layer was extracted, dried with sodium sulfate, filtered, and concentrated. Next, the residue was washed with acetone and methanol, and was filtered to provide an intermediate 1 in a yield of 22.0 g and a percentage yield of 72.0%, and at a purity of 99.6% (HPLC:UV 230 nm).

(Synthesis of Exemplified Compound C-45)

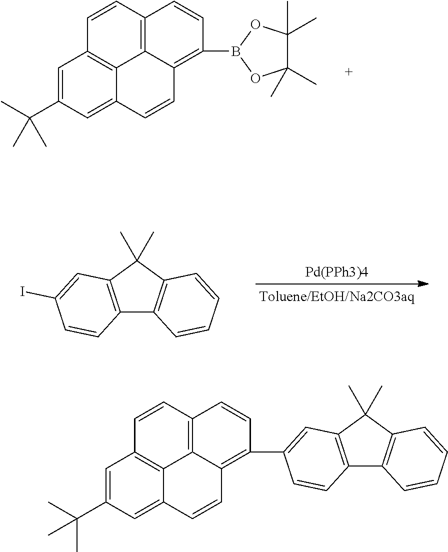

2.56 Grams (6.65 mmol) of 9,9-dimethyl-2-iodofluorene (Mw=320.17), 2.82 g (7.33 mmol) of the intermediate 1, 0.63 g (0.54 mmol) of tetrakis(triphenylphosphine)palladium, 4.00 g (37.8 mmol) of sodium carbonate, 80 ml of toluene, 40 ml of ethanol, and 36 ml of water were loaded into a reaction vessel, and the mixture was heated to a reflux temperature (about 74° C.) to be subjected to a coupling reaction. After the reaction had been performed for about 5 hours under a reflux condition, the reaction mixture was cooled to room temperature. An organic phase and an aqueous phase were separated from each other with a separating funnel, and the resultant organic phase was purified with a column to provide Exemplified Compound C-45 in a yield of 1.88 g and a percentage yield of 62.74%.

### Synthesis Example 2

(Synthesis of Exemplified Compound C-42)

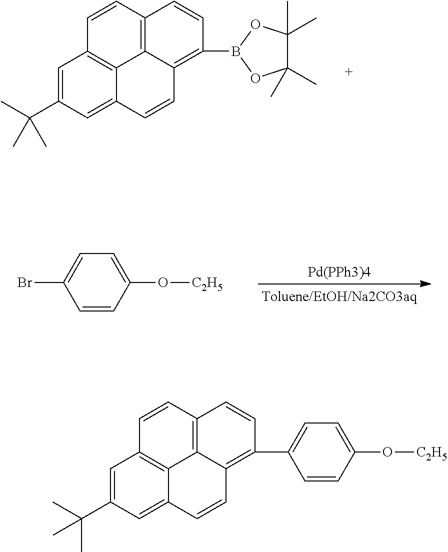

Compound C-42 (Mw=378.51) was obtained in the same manner as in Synthesis Example 1 except that 1.34 g (6.65 mmol) of 4-bromo-1-ethoxybenzene (Mw=201.06) was used instead of 9,9-dimethyl-2-iodofluorene used in Synthesis Example 1. The yield was 2.01 g and the percentage yield was 80.49%.

### Example 1

(Production of Toner Particles)

25 Parts of NUCREL N1525 (ethylene-methacrylic acid resin/manufactured by Du Pont-Mitsui Polychemicals) and 75 parts of dodecyl vinyl ether were loaded into a separable flask, and the temperature of the mixture was increased to 130° C. over 1 hour in an oil bath while the mixture was stirred with a three-one motor at 200 rpm. After having been held at 130° C. for 1 hour, the mixture was slowly cooled at a rate of 15° C. per 1 hour to produce a toner particle precursor. The resultant toner particle precursor was of a white paste form. 59.40 Parts of the toner particle precursor, 4.95 parts of Pigment Blue 15:3 serving as a pigment, 0.2 part of aluminum tristearate serving as a charge adjuvant, and 35.45 parts of dodecyl vinyl ether were filled into a planetary bead mill (CLASSIC LINE P-6/Fritsch) together with zirconia beads each having a diameter of 0.5 mm, and the mixture was pulverized at room temperature and 200 rpm for 4 hours to provide a toner particle dispersion (solid content: 20 mass %). The number-average particle diameter of toner particles in the resultant toner particle dispersion measured with NANOTRAC 150 (manufactured by Nikkiso Co., Ltd.) was 0.85 μm.

(Preparation of Liquid Developer)

0.1 Part of hydrogenated lecithin (LECINOL S-10/manufactured by Nikko Chemicals Co., Ltd.) serving as a charge director, 88.6 parts of dipropylene glycol divinyl ether (Exemplified Compound B-19) serving as a polymerizable monomer, 0.3 part of Exemplified Compound A-26 serving as a photopolymerization initiator, 0.5 part of Exemplified Compound C-45 serving as a sensitizer, and 0.5 part of 1,4-diethoxynaphthalene serving as a sensitizing aid were added to 10.0 parts of the toner particle dispersion. Thus, a UV-curable liquid developer was obtained.

(Evaluation)

(Developability)

An electrostatic pattern was formed on electrostatic recording paper at a surface charge of 500 V, and was developed with the liquid developer and a roller developing machine. Whether or not the resultant image was satisfactory was visually observed.
AA: A high-density and high-definition image was obtained.
A: Slight density unevenness was present, or slight image blurring was observed, but the density unevenness or the image blurring was at such a level that no problem occurred.
B: The pattern could not be sufficiently developed.

(Fixability)

Each liquid developer was dropped onto a polyethylene terephthalate film under an environment at room temperature, i.e., 25° C. and a humidity of 50%, and bar coating was performed with a wire bar (No. 6). After that, the developer was irradiated with light having a wavelength of 365 nm by using a high-pressure mercury lamp having a lamp output of 120 mW/cm² to form a cured film. The dose of the light when the developer completely cured without any tackiness on its surface was measured and ranked as described below.
Rank 10: 100 mJ/cm²
Rank 9: 150 mJ/cm²
Rank 8: 200 mJ/cm²
Rank 7: 300 mJ/cm²
Rank 6: 400 mJ/cm²
Rank 5: 800 mJ/cm²
Rank 4: 1,000 mJ/cm²
Rank 3: 1,500 mJ/cm²
Rank 2: 2,000 mJ/cm²
Rank 1: not cured

With regard to the fixability, a rank of 6 or higher was regarded as passing.

(Simple Test for Apparatus Maintainability)

Under an environment having a temperature of 25° C. and a humidity of 50%, the top of a polyethylene terephthalate film was subjected to bar coating with each liquid developer by using a wire bar (No. 6), and the resultant was left to stand under a fluorescent lamp light source having an illuminance of 300 lm/m² for 1.5 hours. After that, the presence or absence of the curing of the liquid developer was observed.
A: The curing under the fluorescent lamp is not observed.
B: The curing under the fluorescent lamp is observed.

### Examples 2 to 25 and Comparative Examples 1 to 5

UV-curable liquid developers were obtained by using the toner particle dispersion obtained in Example 1, the charge director, and the polymerizable monomer in the same manner as in Example 1 except that the compositions of the photopolymerization initiator and the sensitizer were changed as shown in Table 1 and Table 2. In each of Examples 9 and 10, no sensitizing aid was incorporated. In addition, in each of Examples 16 to 24, CPI-210S (manufactured by San-Apro Ltd.; triarylsulfonium salt-based polymerization initiator, represented as A-28) was used as a polymerization initiator, and its content was set to 1 part. In Example 25, the amount of dipropylene glycol divinyl ether (Exemplified Compound B-19) serving as the polymerizable monomer of Example 11 was set to 80 parts, and 8.6 parts of Exemplified Compound B-34 (average molecular weight: 3,150) was added as a high-molecular weight vinyl ether compound. In addition, in Comparative Example 5, no sensitizer was incorporated.

The same evaluations as those of Example 1 were performed by using the UV-curable liquid developers thus obtained. The results of the evaluations are shown in Table 1.

The structures of the sensitizers used in Comparative Examples are as shown below.

(Sensitizer)

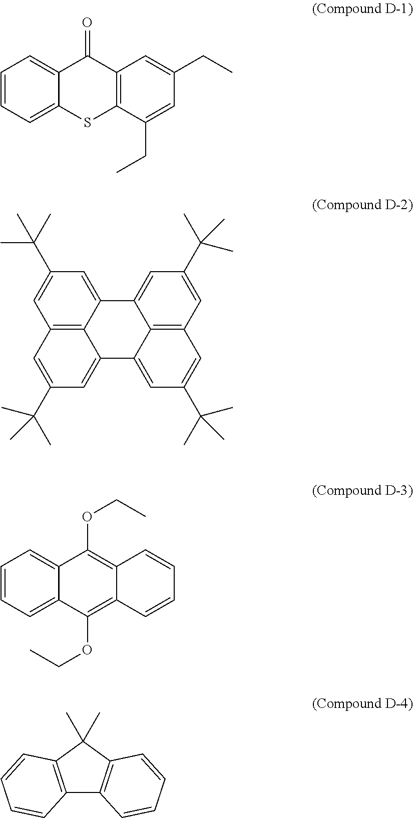

TABLE 1

| | | | Developer evaluation | | | |
|---|---|---|---|---|---|---|
| | Developer construction | | | | Absorption | |
| | Sensitizer | Initiator | Fixability | Developability | at 400 nm | Maintainability |
| Example 1 | C-45 | A-26 | 10 | AA | Absent | A |
| Example 2 | C-42 | A-26 | 10 | AA | Absent | A |
| Example 3 | C-1 | A-26 | 10 | AA | Absent | A |
| Example 4 | C-33 | A-26 | 10 | AA | Absent | A |
| Example 5 | C-50 | A-26 | 10 | AA | Absent | A |
| Example 6 | C-51 | A-26 | 10 | AA | Absent | A |
| Example 7 | C-57 | A-26 | 10 | AA | Absent | A |
| Example 8 | C-82 | A-26 | 10 | AA | Absent | A |
| Example 9 | C-42 | A-26 | 9 | AA | Absent | A |
| | No sensitizing | | | | | |
| | aid | | | | | |
| Example 10 | C-57 | A-26 | 9 | AA | Absent | A |
| | No sensitizing | | | | | |
| | aid | | | | | |
| Example 11 | C-45 | A-18 | 9 | AA | Absent | A |
| Example 12 | C-22 | A-18 | 9 | AA | Absent | A |
| Example 13 | C-61 | A-18 | 9 | AA | Absent | A |
| Example 14 | C-52 | A-18 | 9 | AA | Absent | A |
| Example 15 | C-60 | A-18 | 9 | AA | Absent | A |
| Example 16 | C-45 | A-28 | 8 | A | Absent | A |
| Example 17 | C-66 | A-28 | 8 | A | Absent | A |
| Example 18 | C-74 | A-28 | 8 | A | Absent | A |
| Example 19 | C-89 | A-28 | 7 | A | Absent | A |
| Example 20 | C-98 | A-28 | 7 | A | Absent | A |
| Example 21 | C-105 | A-28 | 7 | A | Absent | A |
| Example 22 | C-131 | A-28 | 6 | A | Absent | A |
| Example 23 | C-133 | A-28 | 6 | A | Absent | A |
| Example 24 | C-134 | A-28 | 6 | A | Absent | A |
| Example 25 | C-45 | A-18 | 10 | AA | Absent | A |
| Comparative | D-1 | A-28 | 8 | A | Present | B |
| Example 1 | | | | | | |
| Comparative | D-2 | A-28 | 7 | A | Present | B |
| Example 2 | | | | | | |
| Comparative | D-3 | A-28 | 7 | A | Present | B |
| Example 3 | | | | | | |
| Comparative | D-4 | A-28 | 3 | A | Absent | A |
| Example 4 | | | | | | |
| Comparative | None | A-28 | 1 | A | — | A |
| Example 5 | | | | | | |

* Absorption at a wavelength of 400 nm was measured in a toluene solution.

It was judged that the effects of the present invention were obtained in a UV-curable liquid developer satisfying the following conditions: in Table 1, the fixability was 6 or higher, and the result of each of all evaluation items, i.e., the developability and the maintainability was AA or A.

In Examples 8 and 9, no sensitizing aids were incorporated into Examples 2 and 7, respectively. In each of the examples, however, a reduction in fixability was slight and hence sufficient effects were obtained even without any sensitizing aid.

In each of Examples 19 to 25, the fixability reduced to some extent owing to the presence of a heteroatom in a ring constituting the sensitizer, but was at such a level that no problem occurred at the time of the use of the developer.

It is found that in each of Comparative Examples 1 to 3 each serving as the related art, a sensitizer having absorption in the visible light region is used, and hence the maintainability is poor and fluorescent lamp resistance is absent. In addition, it is found that in Comparative Example 4, the absorption edge of the sensitizer is present at a wavelength as short as about 340 nm, and hence a sensitizing action is weak and the fixability is poor. Further, it is found that in Comparative Example 5 free of any sensitizer, the developer cannot be sufficiently fixed.

### Examples 26 to 31 and Comparative Examples 6 to 8

(Preparation of UV-Curable Composition)

In each of Examples 26 to 31, and Comparative Examples 6 and 7, a UV-curable composition was produced by incorporating 95.0 parts of 1,6-hexanediol diacrylate (manufactured by Osaka Organic Chemical Industry Ltd.) serving as a radical polymerizable liquid monomer, 4.0 parts of IRGACURE 369 (manufactured by BASF Japan Ltd.) represented by Compound E-1, which was a hexaallylbisimidazole-based photoradical photopolymerization initiator, serving as a photopolymerization initiator, and 1.0 part of each of such sensitizes as shown in Table 2. In Comparative Example 8, a UV-curable composition was produced as follows: 5.0 parts of an acylphosphine oxide-based photoradical initiator Lucirin TPO (manufactured by BASF Japan Ltd.) represented by Compound E-2 was added as a photopolymerization initiator instead of Compound E-1, no sensitizer was added, and the amount of the monomer was set to 95 parts.

With regard to evaluations, the same tests as those of Example 1 were performed for fixability and maintainability.

(Polymerization Initiator)

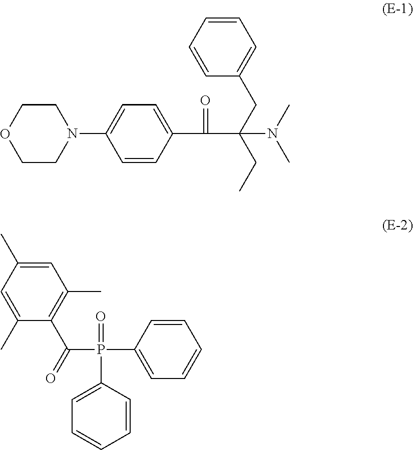 [SMILES: CCC(Cc1ccccc1)(C(=O)c1ccc(N2CCOCC2)cc1)N(C)C ; Cc1cc(C)c(C(=O)P(=O)(c2ccccc2)c2ccccc2)c(C)c1]

TABLE 2

| | UV-curable | | | | |
|---|---|---|---|---|---|
| | composition | | Evaluation | | |
| | construction | | | Absorption | Main- |
| | Sensitizer | Initiator | Fixability | at 400 nm | tainability |
| Example 26 | C-45 | E-1 | 8 | Absent | A |
| Example 27 | C-54 | E-1 | 8 | Absent | A |
| Example 28 | C-69 | E-1 | 8 | Absent | A |
| Example 29 | C-92 | E-1 | 7 | Absent | A |
| Example 30 | C-100 | E-1 | 7 | Absent | A |
| Example 31 | C-108 | E-1 | 7 | Absent | A |
| Comparative | D-1 | E-1 | 8 | Present | B |
| Example 6 | | | | | |
| Comparative | D-2 | E-1 | 7 | Present | B |
| Example 7 | | | | | |
| Comparative | None | E-2 | 6 | Initiator has | B |
| Example 8 | | | | absorption | |

* Absorption at a wavelength of 400 nm was measured in a toluene solution.

The evaluations were performed by the same approaches as those for a UV-curable liquid developer.

A UV-curable composition satisfying the following conditions was regarded as passing: in Table 2, the fixability was 6 or higher and the fluorescent lamp resistance was A. In each of Comparative Examples 6 and 7 each serving as the related art, the fixability was obtained, but the absorption was present at a wavelength of 400 nm, and hence the maintainability, i.e., the fluorescent lamp resistance was not obtained. In addition, the polymerization initiator of Comparative Example 8 had an absorption peak at a wavelength of 380 nm, and hence the UV-curable composition was cured with a LED having a wavelength of 385 nm even without any sensitizer. On the other hand, however, the composition had absorption at about 420 nm as well and was hence free of any fluorescent lamp resistance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-107592, filed May 27, 2015, and Japanese Patent Application No. 2016-099608, filed May 18, 2016, which are hereby incorporated by reference herein in their entirety.

1. A UV-curable liquid developer, comprising:
toner particles;
a photopolymerization initiator;
a sensitizer; and
a polymerizable monomer,
wherein the sensitizer contains a compound represented by the following formula (1):
X—Y (1)
in the formula (1):
X represents one functional group selected from the group consisting of a triphenylenyl group, a phenanthrenyl group, a pyrenyl group, a fluoranthenyl group, a fluorenyl group, a chrysenyl group, a carbazolyl group, a dibenzofuranyl group, a dibenzothiophenyl group, and a naphthyl group;
Y represents one functional group selected from the group consisting of a triphenylenyl group, a phenanthrenyl group, a pyrenyl group, a fluoranthenyl group, a fluorenyl group, a chrysenyl group, a carbazolyl group, a dibenzofuranyl group, a dibenzothiophenyl group, a naphthyl group, a phenyl group, a biphenyl group, and a terphenyl group; and
X and Y may each independently have a substituent selected from the group consisting of an alkyl group, a fluoroalkyl group, a cycloalkyl group, an alkenyl group, a cycloalkenyl group, an alkoxy group, an alkylthio group, a hydroxy group, a halogen atom, a cyano group, a carbonyl group, a carboxy group, an oxycarbonyl group, a carbamoyl group, an amino group, a silyl group, a nitro group, and a sulfonic group.

2. A UV-curable liquid developer according to claim 1, wherein the substituent of each of the X and Y comprises one of an alkyl group and an alkoxy group each having 1 or more and 8 or less carbon atoms.

3. A UV-curable liquid developer according to claim 1, wherein:
the X represents one functional group selected from the group consisting of a triphenylenyl group, a phenanthrenyl group, a pyrenyl group, a fluoranthenyl group, a fluorenyl group, a chrysenyl group, and a naphthyl group each having a sub stituent; and
the Y represents one functional group selected from the group consisting of a triphenylenyl group, a phenanthrenyl group, a pyrenyl group, a fluoranthenyl group, a fluorenyl group, a chrysenyl group, a naphthyl group, a phenyl group, a biphenyl group, and a terphenyl group each having a sub stituent.

4. A UV-curable liquid developer according to claim 1, wherein the photopolymerization initiator contains a compound represented by the following formula (2): 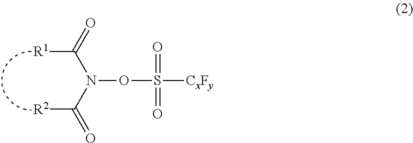
in the formula (2), R¹ and R² represent groups that are bonded to each other to form a cyclic imide structure, x represents an integer of 1 or more and 8 or less, and y represents an integer of 3 or more and 17 or less.

5. A UV-curable liquid developer according to claim 1, wherein the photopolymerization initiator contains a compound represented by the following formula (3): 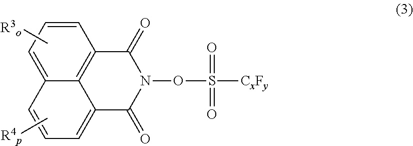
in the formula (3), R³ and R⁴ each independently represent a substituent selected from the group consisting of an alkyl group, an alkyloxy group, an alkylthio group, an aryl group, and an aryloxy group, and o and p each independently represent an integer of 0 or more and 3 or less.

6. A method of fixing a UV-curable liquid developer, comprising irradiating the UV-curable liquid developer with UV light having a wavelength of 360 nm or more and 390 nm or less to cure the UV-curable liquid developer,
wherein the UV-curable liquid developer, comprising:
toner particles;
a photopolymerization initiator;
a sensitizer; and
a polymerizable monomer,
wherein the sensitizer contains a compound represented by the following formula (1):
X—Y (1)
in the formula (1):
X represents one functional group selected from the group consisting of a triphenylenyl group, a phenanthrenyl group, a pyrenyl group, a fluoranthenyl group, a fluorenyl group, a chrysenyl group, a carbazolyl group, a dibenzofuranyl group, a dibenzothiophenyl group, and a naphthyl group;
Y represents one functional group selected from the group consisting of a triphenylenyl group, a phenanthrenyl group, a pyrenyl group, a fluoranthenyl group, a fluorenyl group, a chrysenyl group, a carbazolyl group, a dibenzofuranyl group, a dibenzothiophenyl group, a naphthyl group, a phenyl group, a biphenyl group, and a terphenyl group; and
X and Y may each independently have a substituent selected from the group consisting of an alkyl group, a fluoroalkyl group, a cycloalkyl group, an alkenyl group, a cycloalkenyl group, an alkoxy group, an alkylthio group, a hydroxy group, a halogen atom, a cyano group, a carbonyl group, a carboxy group, an oxycarbonyl group, a carbamoyl group, an amino group, a silyl group, a nitro group, and a sulfonic group.

7. An image forming method, comprising:
a charging step of charging a surface of a photosensitive member;
an exposing step of forming an electrostatic latent image on the surface of the photosensitive member through exposure;
a developing step of developing the formed electrostatic latent image with a developer to form a toner image;
a transferring step of transferring the toner image onto a recording medium; and
a fixing step of fixing the transferred toner image to the recording medium,
wherein:
the developer comprises a UV-curable liquid developer; and
the fixing step includes irradiating the UV-curable liquid developer with UV light having a wavelength of 360 nm or more and 390 nm or less to cure the UV-curable liquid developer,
wherein the UV-curable liquid developer, comprising:
toner particles;
a photopolymerization initiator;
a sensitizer; and
a polymerizable monomer,
wherein the sensitizer contains a compound represented by the following formula (1):
X—Y (1)
in the formula (1):
X represents one functional group selected from the group consisting of a triphenylenyl group, a phenanthrenyl group, a pyrenyl group, a fluoranthenyl group, a fluorenyl group, a chrysenyl group, a carbazolyl group, a dibenzofuranyl group, a dibenzothiophenyl group, and a naphthyl group;
Y represents one functional group selected from the group consisting of a triphenylenyl group, a phenanthrenyl group, a pyrenyl group, a fluoranthenyl group, a fluorenyl group, a chrysenyl group, a carbazolyl group, a dibenzofuranyl group, a dibenzothiophenyl group, a naphthyl group, a phenyl group, a biphenyl group, and a terphenyl group; and
X and Y may each independently have a substituent selected from the group consisting of an alkyl group, a fluoroalkyl group, a cycloalkyl group, an alkenyl group, a cycloalkenyl group, an alkoxy group, an alkylthio group, a hydroxy group, a halogen atom, a cyano group, a carbonyl group, a carboxy group, an oxycarbonyl group, a carbamoyl group, an amino group, a silyl group, a nitro group, and a sulfonic group.

8. (canceled)
